(19) United States
(12) Patent Application Publication
(10) Pub. No.: US 2026/0290317 A1
(43) Pub. Date: Sep. 24, 2026

(54) SYSTEM

(71) Applicant: SoftBank Group Corp., Tokyo (JP)

(72) Inventor: Yuta ARUGA, Tokyo (JP)

(73) Assignee: SoftBank Group Corp., Tokyo (JP)

(21) Appl. No.: 19/558,791

(22) Filed: Mar. 6, 2026

(30) Foreign Application Priority Data
Mar. 19, 2025 (JP) 2025-044524

(51) Int. Cl. G10L 13/08; G06F 16/215; G06F 16/34; G06F 16/953

(52) U.S. Cl. CPC G10L 13/08; G06F 16/215; G06F 16/345; G06F 16/953

(57) ABSTRACT

A system includes a processor that is configured to receive an input from a user and generate a search query for acquiring related information from the Internet, analyze acquired information by using a natural language processing technique and generate a prompt sentence for instructing a generative AI model to generate audio data, and convert an analysis result into audio data by using a speech synthesis technique based on an instruction from the generative AI model.

### CROSS-REFERENCE TO RELATED APPLICATION

This application is based on and claims priority under 35 USC 119 from Japanese Patent Application No. 2025-044524 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information delivery systems that obtain information from the Internet and present it to users are primarily designed for visual consumption, such as through web pages, texts, or graphical user interfaces. As a result, users who are in situations where visual attention is limited or unavailable, for example during driving, commuting, performing housework, or when visually impaired, face significant difficulty in efficiently acquiring up-to-date information from online sources. Furthermore, even when speech synthesis is employed, existing systems typically provide simple text-to-speech conversion without sufficiently leveraging natural language processing or generative AI models to select and structure relevant content, to generate appropriate instructions for audio generation, and to adjust the resulting audio data according to the user's context. Therefore, there is a need for a system that automatically acquires related information from the Internet based on user input, analyzes the acquired information using natural language processing, cooperates with a generative AI model to generate audio data, and adjusts the audio data such that the analyzed information can be provided auditorily in situations where visual acquisition is difficult.

### SUMMARY

In order to solve the above-described problem, a system according to one or more embodiments of the present invention comprises a processor. The processor is configured to receive an input from a user and to generate a search query for acquiring related information from the Internet. The processor is further configured to analyze acquired information by using a natural language processing technique and to generate a prompt sentence for instructing a generative AI model to generate audio data. In addition, the processor is configured to convert an analysis result into audio data by using a speech synthesis technique based on an instruction from the generative AI model. Moreover, the processor may be configured to select related information based on the input from the user and to generate a prompt sentence for instructing the generative AI model to analyze the selected related information. The processor may also be configured to adjust the audio data based on the instruction from the generative AI model such that analyzed information is provided auditorily to a user in a situation in which visual acquisition of the analyzed information is difficult. By these configurations, the system can automatically acquire, analyze, and convert Internet-based information into appropriately adjusted audio data, thereby enabling efficient auditory provision of information in contexts where visual consumption is constrained.

The term “system” refers to an information processing apparatus, or a combination of hardware and software components, configured to execute the functions recited in the claims, including acquiring, analyzing, and converting information into audio data.

The term “processor” refers to a hardware device or circuitry, such as a central processing unit (CPU), graphics processing unit (GPU), microcontroller, or dedicated processing circuitry, which executes instructions to perform the operations described in the claims.

The term “user” refers to a person or entity that provides input to the system and receives information output, including audio data, from the system.

The term “input” refers to data, commands, preferences, queries, or any other information provided by the user to the system through an input interface, such as a keyboard, touchscreen, microphone, or network interface.

The term “search query” refers to a structured or unstructured string, command, or data set that is generated by the processor based on the user input and is used to retrieve related information from resources available on the Internet.

The term “related information” refers to information, such as text, metadata, or content items, that is obtained from the Internet in response to the search query and is relevant to the user's input or request.

The term “Internet” refers to a global network of interconnected computer networks that enables the exchange of data and access to online resources, including web pages, databases, and application programming interfaces.

The term “natural language processing technique” refers to any algorithm, model, or method for processing, analyzing, understanding, or transforming human language text, including but not limited to tokenization, parsing, classification, summarization, and semantic analysis.

The term “generative AI model” refers to an artificial intelligence model, including but not limited to a machine learning or deep learning model, configured to generate content or instructions, such as text or control signals, based on input data or prompts.

The term “prompt sentence” refers to a piece of text or structured instruction generated by the processor and provided to the generative AI model to specify a task, such as generating audio data or analyzing selected related information.

The term “audio data” refers to digital data representing sound, including spoken narration, synthesized speech, music, or sound effects, in any suitable audio format.

The term “speech synthesis technique” refers to a method, algorithm, or system for converting text or symbolic representation of language into audio data representing human-like speech.

The term “analysis result” refers to information obtained by applying a natural language processing technique to the acquired related information, such as summarized text, extracted key points, or structured semantic representations.

The term “selected related information” refers to a subset of the related information that is chosen by the processor based on the user input, relevance criteria, or predetermined rules for further analysis or processing.

The term “analyzed information” refers to information that has been processed by the generative AI model or by the natural language processing technique, and that is intended to be provided to the user in the form of audio data.

The term “adjust” in relation to audio data refers to modifying one or more characteristics of the audio data, including but not limited to volume, speed, intonation, segmentation, ordering, or inclusion of additional sounds, in accordance with instructions from the generative AI model.

The term “situation in which visual acquisition is difficult” refers to any circumstance in which a user has limited or no ability to visually perceive information, including but not limited to driving, commuting, performing housework, being in a dark environment, or having a visual impairment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

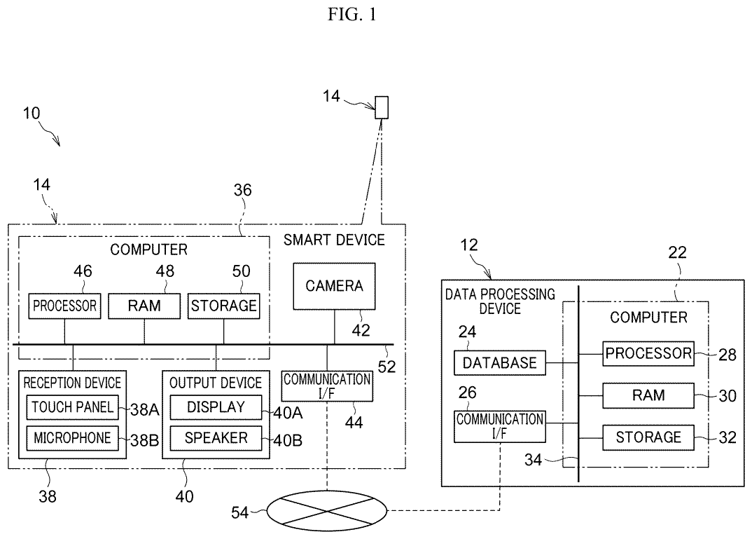

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

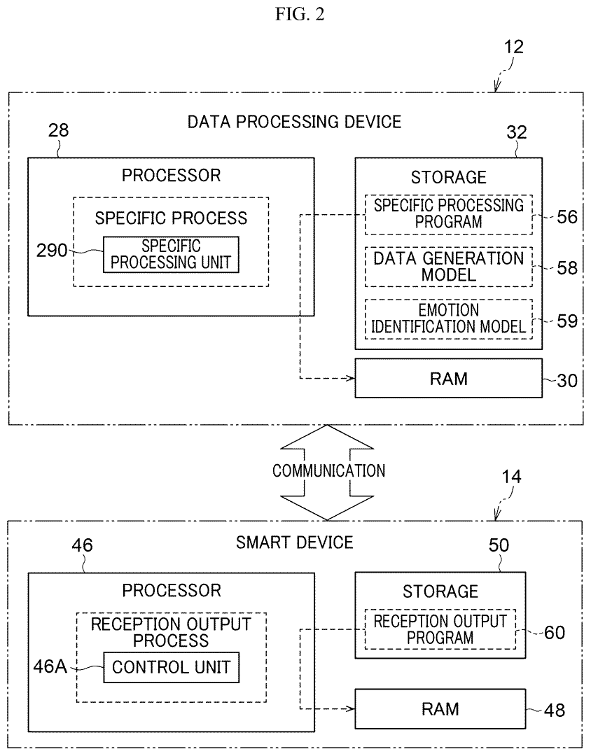

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for providing audio news or other information content typically rely on fixed rule-based pipelines that directly convert preselected textual content into speech. Such systems have several technical limitations. First, a processor in a conventional system often treats a user's natural language request as a simple keyword string, without structurally interpreting the user's intent, temporal scope, or desired audio characteristics. As a result, the processor generates search queries that are either too broad or too narrow, increasing network traffic, storage access, and processor cycles due to retrieval of low-relevance content and repeated user retries.

Second, conventional text-to-speech pipelines typically do not generate intermediate, machine-optimized description texts specifically tailored for spoken delivery. Instead, they pass raw article text directly into a speech synthesis module. This leads to inefficient use of computing resources: the speech synthesis engine processes unnecessary or redundant sentences, and the resulting audio frequently contains duplicated or low-priority information. In addition, the processor does not systematically apply importance evaluation, duplicate elimination, and summarization before speech synthesis, which increases processing time, memory usage, and energy consumption, particularly on resource-constrained terminals.

Third, existing systems are often static with respect to user feedback. When a user desires a shorter playback time, a simpler explanation level, or a focus on particular subtopics, the processor generally cannot dynamically incorporate such constraints into the content generation and delivery pipeline. User interfaces may allow stopping or skipping, but the backend processing remains unchanged, so network resources and server-side processing are repeatedly wasted generating unsuitable audio data, and the user must adapt to the machine instead of the machine adapting to the user.

Fourth, many systems treat server-side processing and terminal-side speech synthesis as separate, loosely coupled components. There is no coherent, machine-readable control structure, such as speech synthesis markup with segmentation and emphasis metadata, that is explicitly generated by the server and consumed by the terminal's speech engine. As a consequence, the terminal's speech synthesis engine operates with limited contextual information, resulting in suboptimal prosody, increased trial-and-error rendering, and redundant processing on the terminal side.

Therefore, there is a need for an improved computer-implemented system in which a processor: (i) uses a generative AI model to transform a user's natural language input into a structured search query candidate and audio output conditions; (ii) performs importance-aware retrieval, ranking, and summarization of multiple information contents; and (iii) generates explicit speech synthesis instruction information consumable by a terminal. Such a system should reduce unnecessary data retrieval, optimize CPU and memory usage for natural language processing and speech synthesis, and allow dynamic adjustment of audio output parameters in response to user feedback, thereby improving overall computer system efficiency and user experience.

The specific processing by the specific processing unit 290 of the data processing device 12 in Example 1 is realized by the following means.

The present invention provides a server comprising a processor configured to receive a natural language input from a user via a terminal, normalize the natural language input, and generate and transmit a prompt sentence to a generative information processing model so as to convert the natural language input into a search query candidate including search condition information and audio output condition information; to acquire, on the basis of the search query candidate obtained from the generative information processing model, a plurality of information contents from an information providing apparatus over an information communication network, perform natural language processing on content of the plurality of information contents to execute importance evaluation, duplicate elimination, and summarization processing, and generate a description text for listening; to add, to the description text, speech synthesis instruction information including segmentation information and emphasis information based on a standard description language for speech synthesis, and transmit text data including the speech synthesis instruction information to the terminal; and to calculate, on the basis of keyword information and time range information included in the search query candidate, a relevance score for each of the plurality of information contents, rank the plurality of information contents on the basis of the relevance score and publication time information, and integrally summarize selected information contents into the description text for listening by using the natural language processing and the generative information processing model, and to update, in response to additional input from the user indicating at least one of a playback time condition, an expression difficulty condition, and an interest field condition, the prompt sentence for the generative information processing model and regenerate the description text and the speech synthesis instruction information so as to adjust at least one of a length, a speaking rate, and a content detail level of audio data provided to the user. This enables the server and terminal, as a combined computer system, to reduce retrieval of irrelevant content, decrease redundant natural language processing and speech synthesis operations, and dynamically adapt audio output generation to user-specific constraints, thereby improving processing efficiency, resource utilization, and responsiveness of the overall information delivery architecture.

The term “processor” refers to a hardware computation unit or a combination of hardware computation units, including at least one central processing unit and optionally one or more accelerator units, that executes machine-readable instructions to perform data processing, control, and communication functions of the system.

The term “terminal” refers to an information processing apparatus, such as a mobile device, a personal computer, or an embedded device, that communicates with the server, provides an input interface for a user, and outputs audio or other information to the user.

The term “user” refers to a human operator who interacts with the terminal and the system by providing input and receiving output, including audio information generated by the system.

The term “natural language input” refers to textual or speech-based information expressed in a human language and provided by the user to the system as a request, instruction, or query.

The term “normalize” refers to processing the natural language input to a standardized internal representation, including at least one of converting character case, removing control characters, correcting basic formatting, and segmenting the text.

The term “prompt sentence” refers to a structured text prepared by the processor and provided as input to a generative information processing model, the structured text specifying instructions, constraints, or context to control the behavior of the generative information processing model.

The term “generative information processing model” refers to a machine-learned model, such as a neural network language model, configured to generate structured outputs including text, queries, or summaries in response to input prompts.

The term “search query candidate” refers to a data structure derived from the natural language input by the generative information processing model, the data structure including at least search condition information and optionally audio output condition information for retrieving information contents.

The term “search condition information” refers to parameter data specifying constraints for information retrieval, including at least one of keyword information, time range information, content category information, language information, and source type information.

The term “audio output condition information” refers to parameter data specifying constraints or preferences for audio generation, including at least one of target playback duration, speaking rate, expression difficulty level, and content detail level.

The term “information communication network” refers to a communication infrastructure including at least one of the Internet, a wide area network, a local area network, and a wireless communication network, used for exchanging data between the server, the terminal, and external information providing apparatuses.

The term “information providing apparatus” refers to a remote server, storage system, or service that provides information contents over the information communication network in response to retrieval requests.

The term “information content” refers to a unit of data obtained from the information providing apparatus, including at least text information, and optionally associated metadata such as title, source, publication time, and identifier.

The term “natural language processing” refers to automated computational processing of text expressed in a human language, including at least one of tokenization, sentence segmentation, part-of-speech tagging, named entity recognition, and text summarization.

The term “importance evaluation” refers to processing that assigns a significance measure or score to portions or units of information content based on criteria such as keyword occurrence, semantic relevance, novelty, or source reliability.

The term “duplicate elimination” refers to processing that detects and removes redundant or substantially similar information contents or text segments based on similarity metrics or matching rules.

The term “summarization processing” refers to processing that reduces one or more information contents into a shorter representation that preserves salient information, by using at least one of extractive summarization and abstractive summarization techniques.

The term “description text for listening” refers to a text sequence generated for being converted into audio, the text sequence being arranged and worded in a manner suitable for speech output to a user.

The term “speech synthesis instruction information” refers to control data associated with the description text, including at least segmentation information and emphasis information, used by a speech synthesis engine to control prosody and rendering of the audio.

The term “segmentation information” refers to data that indicates boundaries between sections, sentences, or phrases within the description text, and that is used to control pauses or grouping during speech synthesis.

The term “emphasis information” refers to data that specifies portions of the description text to be pronounced with altered prosodic characteristics, such as increased stress, volume, or pitch, during speech synthesis.

The term “standard description language for speech synthesis” refers to a markup or specification language for controlling speech synthesis, including at least one of a speech synthesis markup language and a similar structured control language.

The term “text data” refers to digital data representing characters or symbols in a machine-readable format, including the description text and optionally embedded or associated markup or instruction information.

The term “audio data” refers to digital data representing sound, including at least data that can be rendered as speech by an audio output device.

The term “output apparatus” refers to a hardware component configured to provide audio or other signals to the user, including at least one of a loudspeaker, a headphone, and an earphone.

The term “keyword information” refers to one or more textual tokens or phrases extracted from or generated for a query, used to identify topics or entities relevant to information retrieval.

The term “time range information” refers to data specifying a temporal constraint or interval, such as a date or period, used in retrieving or filtering information contents.

The term “relevance score” refers to a numerical or ordinal value indicating a degree of correspondence between an information content and the search query candidate, calculated based on criteria including at least keyword information and time range information.

The term “publication time information” refers to metadata indicating a time at which an information content was generated, published, or made available.

The term “integrally summarize” refers to processing that combines a plurality of information contents into a single summarized representation that coherently reflects their collective salient information.

The term “playback time condition” refers to a parameter indicating a desired total duration or range of duration for audio playback of the description text.

The term “expression difficulty condition” refers to a parameter indicating a desired complexity level of language used in the description text, including at least a simpler level or a more detailed and technical level.

The term “interest field condition” refers to a parameter indicating one or more topics, categories, or domains that should be emphasized or prioritized in generating the description text.

The term “content detail level” refers to a parameter indicating a degree of granularity of information included in the description text, such as an outline-level summary or a more detailed explanation.

The term “speaking rate” refers to a speed at which speech synthesis is performed, typically expressed in units of words per minute or a relative rate parameter within the speech synthesis engine.

In one embodiment, a server cooperates with a terminal to implement the claimed system. The server includes at least one hardware processor and a non-transitory computer-readable storage medium storing machine-executable instructions. The terminal includes a hardware processor, a memory, a user interface device such as a touch screen, and an audio output apparatus such as a loudspeaker or an earphone. The server and the terminal communicate over an information communication network that may include a wireless network and the Internet.

The server executes an operating system such as a general-purpose server operating system and executes middleware such as a web server framework and an application server. The server also executes software libraries for natural language processing, such as a tokenization and sentence segmentation library, and a numerical computation framework to run a generative AI model. The generative AI model is implemented, in one example, as a transformer-based neural network including a plurality of self-attention layers, feed-forward layers, and layer normalization units. The model parameters are stored in the server memory and are loaded into main memory and optionally into a graphics processing unit or dedicated accelerator during inference.

The terminal executes an operating system such as a mobile operating system and includes a text-to-speech engine. The text-to-speech engine may be implemented as an on-device synthesis engine supplied by the operating system or as a client library for a network-based speech synthesis service. The terminal further includes an application program that provides a graphical user interface to the user. The application program can be implemented, for example, using a mobile application framework and uses secure communication libraries to exchange data with the server.

The user operates the terminal to input a natural language request. The terminal presents an input field and a send control. The user enters a prompt sentence such as “Find the most important AI technology news from today and prepare it as a short audio summary.” In another example, the user enters a prompt sentence such as “Using a generative AI model, find and summarize the most important AI technology news from today, focusing on new models, regulations, and major product launches, and then provide it as audio.” In yet another example, the user enters a prompt sentence such as “Generate a concise, listener-friendly news script about the latest AI safety and regulation news from this week, suitable for a 5-minute audio clip.”

The terminal converts the user input into a structured message that includes at least the raw text of the prompt sentence, a user identifier, and optionally a language preference and device capability information. The terminal transmits the structured message to the server via an encrypted connection. By offloading interpretation and content generation to the server, the terminal reduces its local computation load and resource consumption.

The server receives the structured message and stores the prompt sentence and associated metadata in a data storage system such as a relational database or key-value store. The server normalizes the prompt sentence by applying character encoding normalization, case folding, and removal of control characters. The server may also perform language detection and tokenize the prompt sentence into tokens using a tokenizer consistent with the vocabulary of the generative AI model.

The server constructs an internal representation of the request in the form of a data structure that includes at least a token sequence, a logical time scope field, a content topic field, and a target audio constraint field. To populate or refine these fields, the server communicates with the generative AI model. The server generates a prompt sentence for the generative AI model that embeds the user's natural language input together with processing instructions. For example, the server may generate an instruction text such as:
“You are a query generator for news search. Analyze the following user request and output: (1) a normalized search query in English; (2) 3 to 7 core keywords; and (3) a time range description. User request: ‘Find the most important AI technology news from today and prepare it as a short audio summary.’”

The server encodes the instruction text and the user request into a sequence of token identifiers according to the vocabulary of the transformer-based generative AI model. The server inputs the token sequence to the model and performs inference by propagating the input through the self-attention layers and feed-forward layers. The model computes attention weights between tokens to capture contextual relationships and generates output token probability distributions at each position. The server selects the most probable tokens or applies a sampling method such as top-k sampling or nucleus sampling, thereby generating an output sequence that includes, for example, a normalized search query and structured keyword and time range information.

The server parses the output sequence and maps segments of the output to specific fields in the internal representation. For instance, the server identifies a substring labeled as “query:” and assigns it to the search query candidate field. Similarly, the server extracts a list of keyword strings and a time range string from the model output and stores them in corresponding fields. By using such structured fields, the server can perform subsequent retrieval and ranking operations more efficiently than if only unstructured text were used. The server uses the search query candidate and associated fields to retrieve information contents from one or more information providing apparatuses. The server constructs requests to external data sources, such as news content repositories, by inserting the search query string, time range constraints, and language filters into network requests. The server sends these network requests over the information communication network and receives response data that typically include a plurality of information contents in structured formats such as markup or serialized text with metadata. The server stores the received information contents and metadata in a temporary storage location.

The server performs natural language processing on the text portions of the information contents. The server uses a segmentation library to split the content into sentences and uses tokenization and part-of-speech tagging to annotate the text. The server computes term frequency or other statistics for the tokens and compares the tokens with the keyword information extracted from the generative AI model. The server assigns an importance score to each information content based on factors such as keyword coverage, source reliability, and closeness of the publication time to the requested time range. The server also computes similarity metrics, such as cosine similarity over vector embeddings of the text, to identify duplicate or highly overlapping information contents. The server removes information contents that exceed a similarity threshold with respect to already selected contents, thereby performing duplicate elimination.

The server ranks the remaining information contents according to their importance scores and publication times. For example, the server may compute a combined score that is a weighted sum of a relevance score and a recency score. The server selects a predetermined number of top-ranked information contents and combines their textual bodies into a composite corpus. The server annotates the corpus with markers indicating boundaries between individual information contents and stores this composite corpus in the internal representation.

The server generates a description text for listening by applying a summarization process to the composite corpus. In one embodiment, the server uses the same generative AI model or another generative AI model configured for summarization tasks. The server constructs a summarization prompt sentence that specifies a target length and a target style. For example, the server may generate a prompt sentence such as:
“Create a spoken-style news script from the following articles about artificial intelligence. Target length: about 3 minutes when read aloud. Style: neutral news anchor, easy to understand for non-experts. Include the main events and avoid redundant details.”

The server concatenates the summarization prompt and the composite corpus and encodes them into token identifiers. The server then executes inference in the generative AI model. The model architecture, including multiple layers of multi-head self-attention and position-wise feed-forward networks, enables the model to capture long-range dependencies across the corpus and to produce coherent summaries that integrate information from multiple articles. During inference, the server applies a decoding strategy, such as beam search with a predefined beam width, to improve the coherence and factual consistency of the generated description text.

The server receives the generated token sequence and decodes it into a text string representing the description text for listening. The server may perform post-processing, such as enforcing a maximum character count to match the desired playback time, correcting punctuation, and expanding certain abbreviations to improve speech intelligibility. The server therefore transforms multiple heterogeneous information contents into a single, speech-optimized description text that is more compact and coherent than a simple concatenation of articles. This transformation reduces the total amount of text that must be processed by the text-to-speech engine, thereby improving processing speed and reducing memory usage. The server further generates speech synthesis instruction information associated with the description text. The server assigns segmentation information by inserting markers at sentence boundaries and at boundaries between major topics. The server also identifies tokens corresponding to entities such as persons, organizations, and key technical terms using a named entity recognition component. The server marks these tokens as emphasis candidates and embeds emphasis instructions in association with them. The server encodes the description text and the associated control information into a markup representation conforming to a standard description language for speech synthesis. For example, the server may insert tags indicating pauses, emphasis, and prosody adjustments.

The server transmits the text data, including the description text and the speech synthesis instruction information, to the terminal. The server may also transmit metadata including a recommended speaking rate and a target playback duration. Because the text data is already summarized and annotated with detailed synthesis instructions, the terminal can perform speech synthesis more deterministically and with fewer trial renderings than if the terminal were required to infer prosody from raw text. This results in reduced computation and energy consumption on the terminal and improved responsiveness.

The terminal receives the text data and parses the markup to extract the description text and the speech synthesis instruction information. The terminal configures the text-to-speech engine according to the received speaking rate, language, and voice parameters. The terminal passes the markup text to the text-to-speech engine, which generates audio data by applying acoustic models and vocoder algorithms to produce waveform samples that correspond to the input text and prosodic instructions. The terminal stores the generated audio data in a local buffer or file and then outputs the audio through the output apparatus. The user listens to the resulting audio news or information summary.

The user may further provide additional input conditions via the terminal. For example, the user may specify a playback time condition such as “limit to about 2 minutes,” an expression difficulty condition such as “use simpler language,” or an interest field condition such as “focus on regulations and safety, not on products.” The terminal sends these additional conditions to the server in association with the original request or as a refinement request. The server updates the internal representation by adjusting the target audio constraint field, such as reducing the target summary length or modifying a target complexity parameter.

The server generates an updated prompt sentence for the generative AI model that incorporates the additional conditions. For example, the server may generate a prompt sentence such as:
“Revise the following news script so that it fits in about 2 minutes when read aloud and uses simple language understandable by laypersons. Emphasize regulations and safety topics over product announcements.”

The server performs another inference run of the generative AI model using the previously generated description text and the updated instructions. The server obtains a revised description text that satisfies the new conditions and repeats the process of generating and transmitting speech synthesis instruction information. In this way, the system allows iterative refinement of audio output without needing to repeat the entire content retrieval stage, thereby optimizing overall computation and network usage.

The server improves computer technology in several ways. By using the generative AI model to transform the user's natural language input into a structured search query candidate and explicit audio output conditions, the server reduces retrieval of irrelevant information contents and lowers network and storage access load. By performing importance evaluation, duplicate elimination, and summarization before text-to-speech, the server reduces the total text volume processed in subsequent stages, thus decreasing processing time and memory usage. By generating explicit speech synthesis instruction information, the server offloads complex prosody inference from the terminal and enables the text-to-speech engine to operate more efficiently, with fewer rendering passes and lower error rates in prosodic patterns. These improvements are not merely automation of human reading and summarizing tasks but instead modify the internal functioning of the computer system, including the arrangement of data structures, the flow of data between modules, and the distribution of processing between the server and the terminal.

The generative AI model used by the server is trained prior to deployment using a large corpus of text data. The server or a training system executes a training algorithm that employs gradient-based optimization. During training, the model receives sequences of tokens and is configured to predict subsequent tokens or masked tokens. The training system computes a loss function, such as cross-entropy between predicted token distributions and ground truth tokens, and updates model parameters using an optimizer such as stochastic gradient descent or an adaptive method. The training system may apply data augmentation techniques, such as random masking of tokens or shuffling of sentence order within a constrained window, to improve generalization. By using this training process, the model learns statistical patterns and context relationships that exceed simple rule-based pattern matching, enabling the model to generate structured outputs such as query candidates and summaries with higher accuracy and consistency.

In alternative embodiments, the server may use different architectures for the generative AI model, such as encoder-decoder architectures or recurrent neural networks, as long as the model can map an input prompt sentence to a structured output. The server may also change the ranking algorithm for information contents, for example by incorporating additional features such as user-specific preference weights or contextual diversity metrics. The terminal may use different speech synthesis engines, including neural vocoder-based systems or concatenative systems, as long as the engine can accept speech synthesis instruction information and generate corresponding audio data.

The system can be implemented in various deployment configurations. In one configuration, the generative AI model and the natural language processing modules execute entirely on the server. In another configuration, a lightweight model or a subset of functions is executed on the terminal for offline or low-latency operation, while the main summarization is still performed on the server. The communication protocol between the server and the terminal can be implemented over different transport layers, including wireless and wired connections. The server can be realized as a single physical machine or a distributed cluster of machines interconnected by a data center network.

By configuring the server, the terminal, and the generative AI model as described above, the system achieves improved technical performance, including faster response times due to reduced unnecessary retrieval and processing, improved summarization accuracy due to context-aware generative modeling, and reduced communication load due to transmission of compact summarized text rather than full raw content. The system further reduces energy consumption on the terminal by offloading complex natural language processing computations to the server and by providing pre-annotated synthesis instructions that simplify speech rendering.

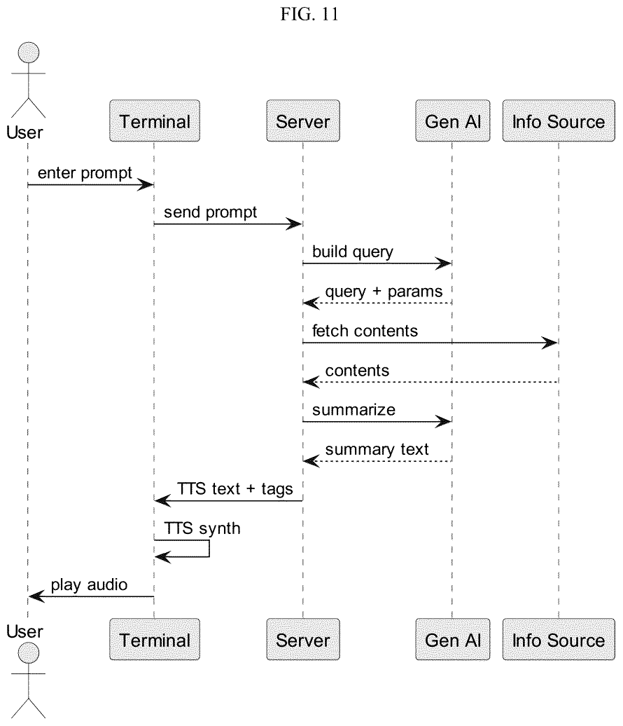

The following describes the processing flow using FIG. 11.
Step 1:

The user operates the terminal to input a prompt sentence. The user views a text input field on the terminal display and types a natural language request such as “Find the most important AI technology news from today and prepare it as a short audio summary.” The user then activates a send control.

Input: The user's raw text prompt sentence and, optionally, user preferences visible on the terminal (language, region, etc.).

Output: A user interaction event and the raw prompt sentence captured by the terminal.
Step 2:

The terminal constructs a request message and transmits it to the server. The terminal packages the raw prompt sentence, a user identifier, and device information into a structured data object. The terminal applies character encoding (e.g., UTF-8) and uses a communication library to send the object via an encrypted network connection to the server.

Input: The raw prompt sentence and local device/user metadata.

Output: A network request containing a structured message delivered to the server.
Step 3:

The server receives and normalizes the prompt sentence. The server parses the incoming structured message, extracts the prompt sentence and metadata, and stores them in a memory structure or database record. The server then performs normalization by applying character encoding normalization, trimming whitespace, converting to a consistent case, and removing control characters. The server may also perform language detection and tokenization.

Input: The structured message from the terminal containing the raw prompt sentence and metadata.

Output: A normalized prompt sentence and an internal request record stored in server memory.
Step 4:

The server generates a prompt sentence for the generative AI model to obtain a search query candidate. The server constructs an instruction text that wraps the normalized prompt sentence and specifies required outputs such as a normalized search query, a list of keywords, and a time range description. The server concatenates the instruction text and the normalized user prompt and encodes this concatenation into a sequence of token identifiers compatible with the vocabulary of the generative AI model.

Input: The normalized prompt sentence and processing rules stored on the server.

Output: A model-input prompt sentence encoded as a token sequence for the generative AI model.
Step 5:

The server performs inference with the generative AI model to produce a structured search query candidate. The server feeds the token sequence into the generative AI model implemented as a transformer-based neural network. The model computes attention weights, propagates activations through self-attention and feed-forward layers, and produces probability distributions over tokens for each output position. The server decodes the model output using, for example, greedy decoding or beam search to obtain text segments that describe a search query, keyword list, and time range. The server then parses these text segments and maps them into fields of an internal data structure representing the search query candidate.

Input: The token sequence representing the model-input prompt sentence.

Output: A structured search query candidate including at least a search query string, keyword information, and time range information.
Step 6:

The server retrieves information contents from one or more information providing apparatuses using the search query candidate. The server constructs network requests by inserting the search query string, time range, and language constraints as parameters for remote data sources. The server sends these requests over the information communication network and receives responses containing multiple information contents and associated metadata such as titles and publication times. The server parses the responses and stores the information contents in an internal collection.

Input: The structured search query candidate containing the search query, keywords, and time range.

Output: A plurality of raw information contents with metadata stored in server memory.
Step 7:

The server filters, ranks, and selects relevant information contents. The server applies natural language processing and statistical analysis to each content: tokenizing, counting occurrences of keywords, and computing similarity scores. The server calculates a relevance score by combining keyword coverage, time proximity, and source reliability. The server detects duplicate or highly similar contents using a similarity threshold and removes them from the collection. The server then sorts the remaining contents by relevance score and publication time and selects a predetermined number of top-ranked contents.

Input: The plurality of raw information contents and the keyword/time range information from the search query candidate.

Output: A filtered and ranked subset of information contents selected for summarization.
Step 8:

The server constructs a composite corpus from the selected information contents. The server extracts the main textual bodies of the selected contents and concatenates them into a single text sequence. The server inserts boundary markers or metadata tags between contents to preserve source separation. The server may remove boilerplate segments such as navigation text or repeated disclaimers.

Input: The selected subset of information contents with their textual bodies.

Output: A composite textual corpus annotated with content boundaries.
Step 9:

The server generates a summarization prompt for the generative AI model. The server creates an instruction text specifying a target summary length, a spoken style, and any additional constraints (for example, “neutral news anchor, easy to understand for non-experts, about 3 minutes when read aloud”). The server appends the composite corpus after this instruction text and encodes the combined text into token identifiers.

Input: The composite corpus and predefined summarization rules or user-specified audio constraints.

Output: A summarization prompt encoded as a token sequence for the generative AI model.
Step 10:

The server performs summarization inference with the generative AI model to obtain a description text for listening. The server inputs the summarization token sequence into the generative AI model. The model processes the sequence using its attention and feed-forward layers, generating a new token sequence that represents a coherent summary. The server decodes this token sequence into natural language text and may enforce length or complexity constraints by truncating or re-requesting a shorter version.

Input: The summarization token sequence containing the instruction text and the composite corpus.

Output: A description text for listening that summarizes the selected information contents.
Step 11:

The server refines and formats the description text for speech output. The server performs sentence segmentation, adjusts punctuation, and expands or reformats abbreviations to improve speech clarity. The server identifies topic boundaries, sentence ends, and key entities, and annotates these positions with markers for pauses and emphasis.

Input: The raw description text for listening from the generative AI model.

Output: A refined description text with internal markers for segmentation and emphasis candidates.
Step 12:

The server generates speech synthesis instruction information and text data in a markup language. The server converts the internal markers into explicit tags in a standard description language for speech synthesis, such as tags for breaks, emphasis, and prosody parameters. The server wraps the description text and tags into a structured markup document and associates language, voice, and speaking rate parameters.

Input: The refined description text with markers and server configuration for speech synthesis parameters.

Output: Text data including the description text and speech synthesis instruction information encoded in a speech synthesis markup representation.
Step 13:

The server transmits the text data and associated parameters to the terminal. The server encapsulates the markup document, language code, voice identifier, and recommended speaking rate into a response object and sends it over the communication network.

Input: The markup text data and synthesis parameter settings.

Output: A response message delivered to the terminal containing text data and speech synthesis instruction information.
Step 14:

The terminal receives and parses the text data. The terminal decodes the response message, extracts the markup text, language, and voice parameters, and configures its text-to-speech engine accordingly. The terminal interprets the markup tags to determine sentence boundaries, pauses, and emphasis positions.

Input: The response message from the server containing markup text and synthesis parameters.

Output: Parsed synthesis configuration and a prepared input for the text-to-speech engine.
Step 15:

The terminal generates audio data using the text-to-speech engine. The terminal supplies the markup text to the engine, which applies linguistic and acoustic models to convert the text and control tags into an internal phonetic and prosodic representation. The engine then runs a vocoder to synthesize waveform samples that represent the spoken summary. The terminal stores the synthesized audio in a buffer or file for playback.

Input: The markup text and synthesis configuration parsed on the terminal.

Output: Audio data representing speech corresponding to the description text and instructions.
Step 16:

The terminal outputs the audio data to the user. The terminal sends the audio data to the audio subsystem, which converts the digital samples into analog signals and drives the speaker or earphones. The terminal may display playback controls and progress indicators while the user listens to the generated audio summary.

Input: The synthesized audio data stored on the terminal.

Output: Audible speech perceived by the user as an audio summary of the requested information.
Step 17:

The user optionally provides refinement input to adjust the audio output. The user may indicate preferences such as “shorter,” “simpler language,” or “focus more on regulations” through controls on the terminal. The terminal collects this additional input and constructs a refinement message that references the previous request.

Input: User feedback and refinement conditions entered on the terminal.

Output: A refinement message containing updated constraints for the server.
Step 18:

The server updates the internal representation and regenerates the description text and instructions. The server receives the refinement message, modifies the target audio constraint fields (for example, target duration, complexity level, target topics), and constructs an updated prompt sentence for the generative AI model that includes the previous description text and the new constraints. The server performs another inference run to obtain a revised description text, re-applies segmentation and emphasis tagging, regenerates markup text data, and sends the updated text data to the terminal for new audio synthesis.

Input: The refinement message from the terminal and the prior description text and metadata stored on the server.

Output: A revised description text, updated speech synthesis instruction information, and a new response message for the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional audio information delivery systems that convert text into audio generally rely on static content selection and fixed text-to-speech pipelines. In such systems, a processor typically retrieves preselected text data, performs straightforward formatting, and then invokes a speech synthesis engine. These systems do not dynamically generate content tailored to a user-selected topic from distributed network resources, nor do they effectively integrate generative AI models with downstream speech synthesis in a way that is optimized for streaming delivery to heterogeneous user terminals. As a result, existing systems suffer from several technical deficiencies in computer-based information processing.

First, conventional systems do not automatically construct machine-usable prompt sentences that instruct a generative AI model to produce an audio-oriented explanation text based on heterogeneous document information retrieved from a plurality of information providing devices. The absence of a structured prompt generation mechanism prevents the processor from exploiting the full capability of generative AI models, leading to suboptimal use of computing resources and increased manual configuration overhead.

Second, conventional text processing pipelines are not designed to transform arbitrary generative AI output into speech-synthesis-ready text in a way that is sensitive to computational constraints such as token limits, latency requirements, and streaming bandwidth. Existing approaches typically treat the generated text as static content and do not include adaptive adjustment processes, such as automatic insertion of delimiters, importance-based summarization, or simplification of technical terms, which are necessary to produce predictable, low-latency audio output well suited for real-time or near real-time streaming.

Third, known systems do not provide a technical mechanism by which a processor automatically consolidates document information from multiple network-based information sources into integrated document information using criteria such as publication time, information-source reliability, and content duplication. Without such integration logic, the processor may perform redundant network requests, process overlapping content, and increase the computational burden on both the retrieval and generative stages, thereby degrading system performance and responsiveness.

Fourth, conventional systems lack a feedback-driven adaptation loop in which the processor updates the generation of prompt sentences and adjustment parameters based on use history information and evaluation information obtained from user operation terminals. In the absence of such a loop, the system cannot optimize the generation of explanation text or audio data per user over time, resulting in inefficient allocation of processing resources and repeated generation of unsuitable content that increases processing load and network traffic.

Fifth, many existing audio delivery systems are not technically optimized to provide audio in situations where visual information acquisition is difficult, such as hands-busy or eyes-busy scenarios. In particular, these systems do not adjust playback speed, volume, delimiter positions, and section structure of audio data based on explanation text characteristics and terminal playback environment. Consequently, they fail to exploit terminal capabilities and network conditions for improving intelligibility and usability, leading to underutilization of the underlying computing and communication infrastructure.

Therefore, there is a need for a computer-implemented system and server-side processing architecture that: (i) automatically retrieves and integrates document information from multiple network information sources based on user-selected topics; (ii) generates structured prompt sentences for generative AI models; (iii) performs adaptive text adjustment to produce speech-synthesis-ready text; (iv) encodes and streams audio data efficiently to user operation terminals; and (v) continuously optimizes these processes through feedback from usage history and user evaluations. Such a system should improve the technical functioning of computers and networks by reducing redundant processing, controlling latency, and enhancing the effectiveness of generative AI integration in an end-to-end audio delivery pipeline.

The specific processing by the specific processing unit 290 of the data processing device 12 in Application Example 1 is realized by the following means.

The present invention provides a server comprising a processor configured to receive topic information from a user operation terminal via an information communication network and, based on the topic information, perform a search process to acquire related document information from one or more information providing devices; analyze the acquired document information using natural language processing to obtain an analysis result; generate a structured prompt sentence based on the topic information and the analysis result for instructing a generative AI model in a generative information processing apparatus to generate an explanation text for audio output; perform, on the explanation text obtained from the generative AI model, an adjustment process including at least one of insertion of delimiters, summarization based on importance, and simplification of technical terms in accordance with speaking time, sentence structure, and user attributes; convert the adjusted explanation text into text data suitable for input to a speech synthesis processing apparatus; cause the speech synthesis processing apparatus to convert the text data into audio data, encode the audio data into a format streamable to the user operation terminal via the information communication network, and transmit the encoded audio data to the user operation terminal; transmit search requests to a plurality of types of information providing devices in accordance with the topic information and predetermined acquisition conditions, generate integrated document information from a plurality of pieces of acquired document information based on at least one of publication time, reliability of an information source, and degree of content duplication, and provide the integrated document information to a process for generating the prompt sentence; and update at least one of instruction contents of the prompt sentence and parameters of the adjustment process, based on use history information and evaluation information acquired from the user operation terminal, so as to optimize generation of the explanation text or the audio data for each user in subsequent processing. This enables improved computer-based information processing by integrating multi-source information retrieval, generative AI prompt construction, adaptive text adjustment, and network-efficient audio streaming into a unified processing pipeline, thereby reducing redundant computation, controlling end-to-end latency, optimizing use of generative AI resources, and enhancing the effectiveness of audio information delivery in conditions where visual information acquisition is difficult.

The term “system” refers to a combination of hardware resources and software resources that cooperate to perform information processing, including at least one server device and one or more user operation terminals interconnected via a communication network.

The term “server” refers to an information processing apparatus including at least one processor and one or more storage devices, the apparatus being configured to execute programs that implement the functions of receiving requests from user operation terminals, processing information, and returning responses via a communication network.

The term “processor” refers to a hardware execution unit, such as a central processing unit or an accelerator, configured to execute instructions of a program to perform arithmetic operations, logic operations, control operations, and data transfer operations for implementing the functions described in the claims.

The term “user operation terminal” refers to an electronic device operated by a user, such as a mobile terminal, a tablet terminal, or a personal computer, the device being configured to transmit topic information and other input data to the server and to receive and reproduce audio data.

The term “information communication network” refers to a wired or wireless communication infrastructure, such as the Internet, a local area network, or a mobile communication network, that enables data exchange between the server, the user operation terminal, and one or more external devices.

The term “topic information” refers to information representing a subject, theme, or field of interest specified by a user, including at least a text string that is used as a basis for retrieving related document information from one or more information providing devices.

The term “information providing device” refers to a device, service, or server system that provides document information via a communication network in response to a request, including but not limited to web servers, database servers, and content distribution services.

The term “document information” refers to information items provided by an information providing device, including at least text data such as article text, title, summary, metadata, or combinations thereof, which are processable by natural language processing.

The term “search process” refers to a process in which the processor generates a query based on topic information and predetermined acquisition conditions, transmits the query to one or more information providing devices, and receives corresponding document information via a communication network.

The term “natural language processing” refers to a set of computational techniques for analyzing and transforming human language text, including at least tokenization, morphological analysis, syntactic analysis, semantic analysis, or summarization.

The term “analysis result” refers to information obtained by applying natural language processing to document information, the information including at least extracted keywords, structured representations, topic-specific features, or summarized content.

The term “generative AI model” refers to a machine learning model trained on large-scale data and configured to generate text or other content based on input data, including models using deep learning architectures such as transformer networks.

The term “generative information processing apparatus” refers to an apparatus, which may be implemented as a local device or a cloud-based service, that executes a generative AI model to generate explanation text or other content in accordance with a prompt sentence.

The term “prompt sentence” refers to a machine-readable instruction text provided to a generative AI model, the text specifying at least a generation task, constraints, style, or content requirements for generating an explanation text based on input information.

The term “explanation text” refers to text generated by a generative AI model in response to a prompt sentence, the text being configured to describe, summarize, or explain content derived from document information in a form suitable for audio output.

The term “adjustment process” refers to a process in which the processor modifies an explanation text according to one or more criteria, the process including at least insertion of delimiters, summarization based on importance, and simplification of technical terms.

The term “delimiter” refers to a mark, symbol, or structural element inserted into text to indicate a boundary between segments, sections, or sentences, and used to control pauses or transitions in subsequent speech synthesis or playback.

The term “summarization based on importance” refers to a processing operation that determines a relative importance of elements in document information or explanation text and selectively retains or emphasizes more important elements while reducing or omitting less important elements.

The term “simplification of technical terms” refers to a processing operation that replaces, explains, or restructures specialized vocabulary or complex expressions with more commonly understandable terms or phrases suitable for general users.

The term “user attributes” refers to information related to a user, such as language preference, proficiency level, listening environment, or usage pattern, which is used to customize the adjustment process or content generation.

The term “text data for speech synthesis” refers to text information, which may include markup, generated from an explanation text and formatted in a manner acceptable as input to a speech synthesis processing apparatus.

The term “speech synthesis processing apparatus” refers to an apparatus or service configured to convert text data for speech synthesis into audio data by using speech synthesis technology, including rule-based methods, statistical methods, or neural network-based methods.

The term “speech synthesis technology” refers to a technological method for generating audio waveforms from text input, including at least text-to-speech (TTS) techniques implemented by software and hardware.

The term “audio data” refers to digital data representing sound, including at least encoded or unencoded waveforms that are suitable for storage, transmission, and playback by electronic devices.

The term “format streamable to the user operation terminal” refers to an encoding format or transmission format of audio data that allows incremental reception and playback by a user operation terminal, including formats such as compressed audio streams or segmented streaming formats.

The term “integrated document information” refers to document information obtained by consolidating a plurality of pieces of document information acquired from a plurality of information providing devices, the consolidation being based on criteria such as publication time, information source reliability, and content duplication.

The term “publication time” refers to temporal information associated with document information, indicating at least a creation time, update time, or release time provided by an information source.

The term “reliability of an information source” refers to an evaluation indicative of trustworthiness or accuracy of document information provided by an information source, the evaluation being determined based on predetermined criteria or historical data.

The term “degree of content duplication” refers to a measure representing similarity or overlap between two or more pieces of document information, the measure being calculated based on text similarity, shared segments, or other comparison metrics.

The term “use history information” refers to information indicating how a user has interacted with audio data or content provided by the system, including at least playback counts, playback duration, or operations such as pauses and skips.

The term “evaluation information” refers to feedback information provided by a user or automatically inferred by the system, the information indicating one or more aspects of user satisfaction, content suitability, or quality of generated audio data or explanation text.

The term “instruction contents of the prompt sentence” refers to specific elements contained in a prompt sentence, including tasks to be executed by the generative AI model, desired style, length constraints, or structural requirements of an explanation text.

The term “parameters of the adjustment process” refers to configuration values or thresholds used by the adjustment process, including at least target speaking time, level of summarization, degree of simplification of technical terms, and rules for delimiter insertion.

The term “subsequent processing” refers to processing of additional or later requests after previous processing has been completed, the processing including at least generation of new explanation text or audio data for a user based on updated parameters or prompt contents.

The term “playback environment of the user operation terminal” refers to conditions under which audio data is reproduced by the user operation terminal, including hardware characteristics, available output devices, network conditions, and user-specified playback settings such as volume and speed.

The term “playback speed” refers to a parameter that determines the rate at which audio data is reproduced, relative to a nominal recording rate, and that may be increased or decreased to adjust listening time or comprehension.

The term “section structure” refers to an organization of an explanation text or audio data into logical segments, such as introductions, main topics, and conclusions, which are used to improve clarity and navigation during playback.

In one embodiment, a server cooperates with one or more terminals operated by users via a communication network. The server includes a processor, a main memory, a nonvolatile storage device, and a network interface. The processor includes at least one central processing unit and may further include a graphics processing unit or other hardware accelerator. The storage device stores executable programs and data structures for implementing topic-based information retrieval, natural language processing, generative AI interaction, text adjustment, and audio streaming. The network interface connects the server to public or private packet-switched networks.

A terminal includes a processor, a memory, a display, a user input interface such as a touch panel or hardware buttons, an audio output device such as a speaker or headphone jack, and a wireless or wired communication interface. The terminal executes an application that presents a user interface for topic selection, receives audio streams from the server, and controls playback. A user uses the terminal to specify topics, submit evaluation information, and consume audio content.

The server stores, in memory, a set of software modules implemented for example in a general-purpose programming language. The modules include a request reception module, a topic interpretation module, a multi-source retrieval module, a natural language processing module, a prompt generation module, a generative AI interaction module, a text adjustment module, an audio generation module, a streaming control module, a user modeling module, and a logging and analytics module. The modules exchange data through defined in-memory data structures in the form of records, lists, and graphs.

The server uses the multi-source retrieval module to interact with external information providing devices. In one configuration, the server accesses news distribution services, document repositories, or web search endpoints through RESTful interfaces over secure HTTP. The server generates machine-readable queries based on topic information and predetermined acquisition conditions, including parameters such as language, time window, and maximum number of documents. The server stores the responses as document records containing at least a document identifier, a title string, a publication time, a source identifier, a content field, and metadata fields.

The server uses the natural language processing module to normalize and analyze the document records. The module tokenizes the content field into lexical tokens using a rule-based tokenizer or a statistical segmenter. The module applies sentence segmentation, part-of-speech tagging, and dependency parsing by utilizing trained language models stored locally. The module computes term frequency-inverse document frequency scores for tokens, generates document vectors using word or sentence embedding models, and identifies key phrases and central sentences. By performing these operations, the server produces analysis results composed of feature vectors, ranked sentence lists, and topic-specific keyword sets.

The server uses the prompt generation module to construct a prompt sentence for a generative AI model. The module retrieves the topic information supplied from the terminal and the analysis results from the natural language processing module. The module forms an instruction template comprising explicit constraints on style, length, and structure. The module then inserts topic-specific phrases, summary of key points, and document snippets into the template, while respecting a maximum token budget determined for the target generative AI model. The prompt sentence is stored as a character sequence in memory.

In one example, the server generates the following prompt sentence:
“Summarize the following news articles about technology into a 3-minute spoken script. Use clear, simple English and short sentences. Begin with a one-sentence overview, then present the three most important stories, each with a short title. Make the script suitable for listening while commuting. Articles: [ARTICLE TEXTS HERE].”

In another example, the server generates a financial-news-oriented prompt sentence:
“Based on the news articles below about global stock markets, create a spoken-style news briefing that lasts about 5 minutes. Start with a high-level summary, then cover major indices, key company moves, and relevant economic indicators. Avoid heavy jargon and briefly explain any technical terms. Output only the script text to be read aloud.”

The server uses the generative AI interaction module to send the prompt sentence to a generative AI model hosted on a generative information processing apparatus. In one embodiment, the generative AI model is a transformer-based neural network with multiple attention layers, a vocabulary embedding matrix, and position encoding. The model parameters, including weight matrices for self-attention and feedforward sublayers, are stored in memory of the generative information processing apparatus. The model receives tokenized prompt data, performs attention-based computations across tokens to capture contextual relationships, and produces a sequence of output tokens representing an explanation text. The server receives the generated explanation text in the form of a text string and associated confidence metrics.

The server enhances computer functioning by using a constrained prompt design in combination with token-budget-aware truncation. The server explicitly limits the number of tokens fed to the generative AI model based on a token budget parameter stored in configuration. The server precomputes token counts using a tokenizer congruent with the model's vocabulary. By discarding low-importance sentences prior to submission to the model, the server reduces the volume of data processed by the model, thereby lowering latency and computational load. This approach differs from human summarization because the server uses quantitative token length constraints and importance scores derived from feature vectors, which humans do not ordinarily compute.

The server uses the text adjustment module to refine the explanation text output by the generative AI model. The module parses the explanation text into sentences and sections using punctuation and structural markers identified by a rule-based parser. The module computes an estimated speech time by summing per-sentence durations derived from average speech rate parameters. When the estimated time exceeds a target speaking time parameter, the module invokes an importance-based sentence selection algorithm. The algorithm ranks sentences using a weighted combination of embedding similarity to the topic vector, presence of key phrases, and position within the text. Less important sentences are removed or condensed by merging their content into neighbor sentences. By performing this structured reduction, the server produces an explanation text whose length is matched to technical constraints of streaming and audio buffering, which improves end-to-end responsiveness.

The server also uses the text adjustment module to insert delimiters and simplify technical terms. The module determines logical boundaries, such as between story sections or topic transitions, using changes in keyword distributions and sentence embeddings. At such boundaries, the module inserts delimiter markers or line breaks that are later mapped to pauses or section markers in speech synthesis markup. For simplification of technical terms, the module references a term-simplification dictionary stored in the storage device, containing pairs of specialized expressions and plain-language equivalents. When a technical term is detected by string matching or embedding similarity, the module replaces it with a corresponding simpler expression or appends a short explanation. This specific rule-based and embedding-assisted substitution procedure differs from human ad-hoc paraphrasing and is executed under explicit computational thresholds, thereby improving intelligibility for diverse listeners without manual intervention.

The server converts the adjusted explanation text into text data for speech synthesis. In one embodiment, the server generates markup text that includes tags specifying pauses, emphasis, and prosodic hints. The server maps delimiter markers to pause tags, maps section titles to emphasis tags, and encodes these annotations in a markup format supported by the speech synthesis processing apparatus. The resulting text data is stored as a byte sequence in memory and passed to the audio generation module.

The server uses the audio generation module to interact with a speech synthesis processing apparatus. The apparatus executes neural text-to-speech models that convert the markup text into audio waveforms. The models include an encoder network that converts character or phoneme sequences into latent representations, a duration or alignment network that aligns text positions with time frames, and a vocoder network that synthesizes audio samples from spectrograms. The speech synthesis processing apparatus returns audio data in a compressed format, such as a sequence of encoded audio frames. The server receives this data, stores it, and optionally re-encodes it into a streaming-optimized container format.

The server uses the streaming control module to prepare audio data for transmission to terminals. The server segments the audio data into chunks of predetermined duration and associates each chunk with sequence numbers and timestamps. The server sets transport-level headers to enable progressive playback and may adapt the encoding bitrate based on network conditions. By segmenting and buffering audio data at the server side, the system reduces jitter and buffering delay at the terminals, thereby improving playback stability.

The server uses the user modeling module to maintain use history information and evaluation information for each user. The module updates per-user records with playback start and end times, pause and skip events, and topic selections. When a user submits explicit feedback, such as a rating or a comment, the server stores this information in association with the relevant audio session. The server computes derived metrics, such as typical listening duration, preferred topics, and average skip positions. The server then updates parameters of the prompt generation module and the text adjustment module based on these metrics. For example, when a user frequently stops playback before completion, the server reduces the target speaking time for that user. When a user indicates that content is “too technical,” the server increases the degree of technical term simplification applied for subsequent explanation texts. These adaptive modifications are governed by deterministic or statistical rules, and the parameters are stored and updated in a structured configuration store, which leads to progressive optimization of system behavior without manual reconfiguration.

The terminal operates an application that interacts with the server. The terminal displays a topic input field and presents options such as “technology,” “global economy,” and “renewable energy.” The user selects or enters a topic and optionally specifies preferences like “short briefing” or “detailed analysis.” The terminal encodes these inputs as a request message and transmits the message to the server. When the terminal receives a response containing a streaming URL or direct audio stream, the terminal configures a media playback component to start buffering and playing the audio. The terminal manages a local buffer to handle network variation and uses the device's audio subsystem to produce sound. The terminal also collects local playback events and sends summarized use history data to the server.

In another embodiment, the server employs alternative generative AI model architectures, such as encoder-decoder sequence models or recurrent neural networks, instead of a transformer-based network. The server adjusts the token budget, prompt structure, and formatting rules to accommodate differences in input length constraints and output behavior. In a further variation, the server executes a locally hosted generative AI model on a hardware accelerator instead of calling a remote generative information processing apparatus, thus decreasing network latency. In such a variation, the server stores the model parameters on its own storage device and executes forward passes directly, using the same prompt sentences described above.

In yet another embodiment, the server uses different natural language processing techniques for importance scoring, such as graph-based ranking where sentences are represented as nodes and similarity edges are weighted by cosine similarity of embeddings. The server executes an algorithm that identifies central nodes in the graph, and uses these nodes as preferred sentences during summarization. This graph-based selection reduces redundancy and improves coverage of main ideas, which leads to more compact yet informative explanation texts and reduces the number of tokens required at both the generative AI and speech synthesis stages.

The server achieves technical effects beyond mere automation of human tasks by restructuring the entire processing pipeline around computational constraints and machine capabilities. The server reduces the amount of data sent to and from external information providing devices and generative AI resources by pre-filtering and integrating document information, thereby decreasing communication load and processing time. The server constrains generative AI processing through token budgets and importance-weighted selection, which directly lowers resource usage on accelerators and shortens response times. The server adapts text for speech synthesis based on estimated speech durations and section structures, thus improving synchronization between text processing and audio generation modules. The server further leverages feedback to adjust model prompts and processing parameters in ways that humans cannot feasibly perform in real time, thereby enhancing overall system efficiency and audio delivery quality.

In all of these embodiments, the server, the terminal, and the generative information processing apparatus cooperate as concrete technical components that handle structured data, execute defined algorithms, and control audio generation and playback. The system thereby improves computer-based handling of networked text resources and streaming audio, yielding improved processing speed, reduced redundancy, and enhanced listener comprehension compared to conventional static text-to-audio pipelines.

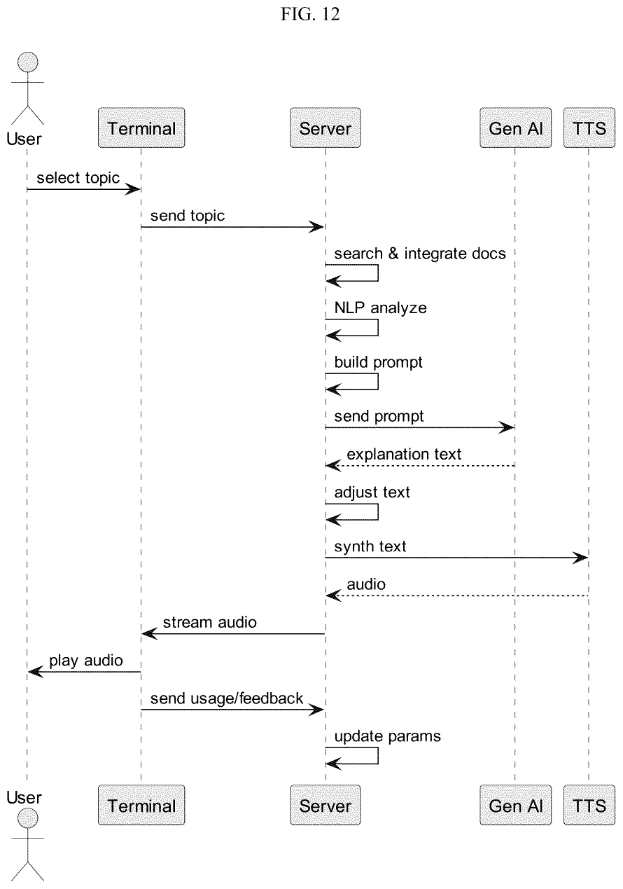

The following describes the processing flow using FIG. 12.
Step 1:

The user operates the terminal to specify topic information and preference information.

The terminal displays an input screen and receives a text string such as “technology” or “global stock markets” as topic information and options such as “short briefing” or “detailed analysis” as preference information.

Input: user touch events and keyboard input on the terminal.

Output: a structured request object in the terminal, including fields for topic, language, desired length, and user identifier.

The terminal converts raw user input events into a normalized data structure, attaches a timestamp and device identifier, and stores this object temporarily in memory.
Step 2:

The terminal transmits the structured request object to the server via a communication network.

Input: the structured request object stored in the terminal.

Output: an HTTP or similar network request sent to the server containing the structured request object in a serialized format.

The terminal uses a communication library to serialize the request object into a message body, adds protocol headers, and sends the message through the network interface to a predefined server address.
Step 3:

The server receives the request and extracts the topic information and preference information.

Input: the network request containing the serialized request object.

Output: internal variables in the server representing topic text, language setting, target duration, and user identifier.

The server uses a network stack to deserialize the message body, parses the content into a structured format, and stores the extracted fields in memory for subsequent processing.
Step 4:

The server performs validation and normalization of the topic information.

Input: raw topic text and preference parameters.

Output: a normalized topic string and sanitized preference parameters suitable for later retrieval and generation.

The server checks the topic text length, removes unsupported characters, applies lowercasing where appropriate, and filters prohibited terms using a predefined ruleset; the server then maps preference labels to numeric parameters such as target_duration_seconds and simplification_level.
Step 5:

The server executes a multi-source search process to retrieve document information from information providing devices.

Input: the normalized topic string, language setting, and acquisition conditions including time window and maximum document count.

Output: a collection of raw document records retrieved from multiple information providing devices.

The server constructs query strings for each external device, sends corresponding network requests, receives response payloads, and converts each payload into document records containing at least title, content, publication time, and source identifier.
Step 6:

The server integrates the raw document records into integrated document information.

Input: the collection of raw document records from different sources.

Output: a single integrated document set with redundant or low-quality records removed and remaining records ranked.

The server calculates similarity scores between document contents, compares publication times, and applies reliability scores of sources; based on these values, the server merges near-duplicate records, discards outdated or low-reliability records, and orders the remaining records by relevance to the topic.
Step 7:

The server applies natural language processing to the integrated document information.

Input: the integrated document set containing text fields and metadata.

Output: analysis results including tokenized text, keyphrase lists, sentence importance scores, and topic feature vectors.

The server tokenizes document texts, segments sentences, and computes vector representations using embedding models; the server then calculates term frequency and similarity measures to assign importance scores to sentences and to extract keyphrases that best represent the topic.
Step 8:

The server constructs a prompt sentence for the generative AI model using the analysis results and topic information.

Input: the topic string, user preferences, and analysis results including key sentences and keyphrases.

Output: a prompt sentence string formatted to instruct the generative AI model to generate an explanation text.

The server selects high-importance sentences, compresses them if necessary to fit a token budget, inserts them into an instruction template, and adds explicit directions about length, structure, and style; the server concatenates these elements into a single character sequence that becomes the prompt sentence.
Step 9:

The server transmits the prompt sentence to the generative AI model and obtains an explanation text.

Input: the prompt sentence string and configuration parameters such as temperature and maximum output length.

Output: an explanation text string generated by the generative AI model.

The server encodes the prompt sentence into tokens, sends them to the generative AI endpoint, receives a sequence of output tokens, and decodes these tokens back into a human-readable explanation text; the server stores the explanation text and any associated metadata such as generation time.
Step 10:

The server performs an adjustment process on the explanation text.

Input: the raw explanation text and user-specific parameters including target speaking time, simplification level, and preferred structure.

Output: an adjusted explanation text with delimiters inserted, content length controlled, and technical terms simplified.

The server splits the explanation text into sentences, estimates the speech duration for each sentence, and removes or compresses low-importance sentences until the total estimated duration matches the target; the server inserts delimiter markers at section boundaries and replaces or annotates technical terms based on a term-simplification dictionary and thresholding rules.
Step 11:

The server converts the adjusted explanation text into text data for speech synthesis.

Input: the adjusted explanation text and delimiter markers.

Output: speech-synthesis-ready text data with markup indicating pauses, emphasis, and section structure.

The server transforms delimiter markers into pause annotations, wraps section titles in emphasis annotations, and encodes the annotated text into a markup format understood by the speech synthesis processor; the server then stores the resulting markup as a structured text object.
Step 12:

The server generates audio data by using a speech synthesis processing apparatus.

Input: the speech-synthesis-ready text data with markup.

Output: encoded audio data representing the spoken explanation.

The server sends the text data to the speech synthesis processor, receives the synthesized waveform in segments or as a continuous stream, and encodes the waveform into a compressed audio format optimized for streaming; the server stores the encoded audio as a sequence of audio frames.
Step 13:

The server prepares the encoded audio data for streaming to the terminal.

Input: the encoded audio frames and network condition parameters.

Output: a stream configuration and audio chunks associated with sequence identifiers and timing information.

The server segments the audio frames into fixed-length chunks, assigns sequence numbers and timestamps, selects an appropriate bitrate based on estimated network conditions, and creates a streaming manifest or response headers that describe the stream layout.
Step 14:

The server transmits the audio stream or audio URL to the terminal.

Input: the streaming configuration, audio chunks, and session identifier associated with the user.

Output: network responses containing either a direct audio stream or a location from which the terminal can pull audio chunks.

The server sends an initial response that includes either streaming headers and the first audio chunks or a URL to a media resource; the server then continues sending or making available subsequent chunks according to the streaming protocol.
Step 15:

The terminal receives the streaming configuration and audio data and initiates playback.

Input: the network response from the server, including audio chunks or a streaming URL.

Output: buffered audio data in the terminal and playback control state indicating that audio playback has started.

The terminal configures a media playback module with the received stream parameters, starts downloading or reading the audio chunks, stores them in a local buffer, and begins decoding and transmitting the audio signal to the speaker or headphones.
Step 16:

The user listens to the audio content and optionally performs playback operations.

Input: the audio output from the terminal and on-screen playback controls.

Output: playback events such as pause, resume, skip, and stop, and subjective feedback such as rating or comments.

The user observes the playback controls displayed by the terminal and performs actions; these actions are captured by the terminal and translated into structured event records that reflect the timing and type of each user operation.
Step 17:

The terminal transmits use history information and evaluation information to the server.

Input: the structured event records and any explicit feedback entered by the user.

Output: a feedback request message sent to the server containing use history information and evaluation information.

The terminal aggregates event records into a summary of playback behavior, combines this summary with feedback fields, and serializes the combined data into a message that is transmitted to the server over the communication network.
Step 18:

The server updates prompt and adjustment parameters based on the received use history information and evaluation information.

Input: the feedback request message containing use history information and evaluation information.

Output: updated configuration parameters for prompt generation and text adjustment stored on the server.

The server analyzes the feedback data to compute metrics such as average listening duration, frequency of early stops, and reported difficulty level; based on these metrics, the server modifies numeric parameters such as target speaking time, degree of summarization, and simplification level for that user or for similar user profiles, and saves these updated parameters for use in future topic requests.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that convert textual information from network sources into audio content typically rely on simple keyword-based retrieval and rule-based text-to-speech pipelines. Such systems suffer from several technical limitations. First, they are not able to interpret a user's natural-language request in a structured manner, and therefore cannot automatically derive detailed acquisition conditions (such as topic scope, time range, language, and desired length) or audio content specifications (such as narrative style, target listener level, or playback duration) from a single prompt sentence. As a result, the processing pipeline is fragmented and requires manual configuration at multiple stages.

Second, existing architectures usually treat information retrieval, natural language analysis, script generation, and speech synthesis as loosely coupled components. These components often operate on unstructured text with minimal normalization, which leads to inefficiencies in memory usage, redundant network access, and duplicated processing. In particular, when large volumes of heterogeneous article data are obtained from a communication network, the lack of systematic normalization, structuring, and deduplication causes excessive processing load and degrades responsiveness of the system.

Third, many known systems do not exploit advanced natural language processing and generative AI models in a coordinated way to transform structured multi-source article data into coherent, topic-focused audio scripts. They commonly either read aloud raw articles or apply shallow summarization, which results in audio content that is redundant, poorly organized, or misaligned with the user's requested style or listening constraints. This limits the effectiveness of the system, especially for users who depend primarily on auditory presentation due to difficulty in visually acquiring information.

Fourth, conventional text-to-speech processing in such pipelines is often applied uniformly, without context-aware adjustment of speaker characteristics, playback speed, pauses, or emphasis based on the semantics of the content or user requirements encoded in the prompt sentence. This leads to audio outputs that are less intelligible or less comfortable to consume over extended periods, and does not adequately address accessibility needs.

Accordingly, there is a need for an improved computer-implemented system and processing architecture that: (i) automatically interprets a user's prompt sentence to derive structured information acquisition conditions and audio content specifications, (ii) performs normalized, structured, and de-duplicated handling of network article information, (iii) coordinates natural language processing with a generative AI model to generate high-quality scripts tailored to the user's intent, and (iv) dynamically optimizes speech synthesis parameters, thereby improving the overall efficiency, robustness, and usability of the audio content generation pipeline executed by a processor.

The specific processing by the specific processing unit 290 of the data processing device 12 in Example 2 is realized by the following means.

The present invention provides a server comprising a processor and a memory storing instructions, wherein the processor is configured to execute the instructions to receive a prompt sentence input by a user via a communication interface, parse the prompt sentence using natural language processing to extract information acquisition conditions and audio content specifications, acquire article information from multiple information sources over a communication network based on the information acquisition conditions, normalize the acquired article information into a unified format, and store the normalized information as structured data in the memory, perform importance scoring and summarization on the structured data using natural language processing to generate topic-based summary information, construct a prompt sentence for a generative AI model based on the summary information and the audio content specifications, transmit the constructed prompt sentence to the generative AI model to request generation of an audio content script, receive the script generated by the generative AI model, apply text correction and segment division to the script to produce text data for speech synthesis, generate audio data from the text data by using speech synthesis processing while adjusting speaker characteristics and playback time in accordance with the prompt sentence or instructions from the generative AI model, store the audio data as a file in a media distribution format together with corresponding metadata, update distribution information based on the metadata, and make the audio data distributable to a terminal in compliance with the media distribution format. This enables the server to implement an integrated and automated processing pipeline that efficiently interprets user intent from a single prompt sentence, performs structured and de-duplicated handling of large-scale network article data, coordinates natural language processing and generative AI-based script generation, and dynamically optimizes speech synthesis parameters, thereby improving the technical performance, scalability, and accessibility of computer-implemented audio content generation.

The term “processor” refers to a hardware computing element, such as a central processing unit or a processing core, that executes machine-readable instructions to perform logical operations, arithmetic operations, data transfers, and control flows required by the system.

The term “prompt sentence” refers to a natural-language text input provided by a user, which describes desired content, conditions, or constraints, and from which the system extracts information acquisition conditions and audio content specifications.

The term “information acquisition conditions” refers to structured parameters derived from the prompt sentence that define how information is to be obtained from information sources, including at least one of a topic, a time range, a language, a geographic scope, a source type, or a quantity of information.

The term “audio content specifications” refers to structured parameters derived from the prompt sentence that define properties of audio content to be generated, including at least one of a desired duration, a narrative style, a target listener level, a language, a tone, or accessibility-related requirements.

The term “communication network” refers to a data communication infrastructure, including wired or wireless networks and the Internet, through which the server exchanges information with external information sources and terminals.

The term “information source” refers to an external data provider accessible over the communication network, including at least one of a web server, an application programming interface endpoint, a database service, or another server that supplies article information.

The term “article information” refers to information items obtained from information sources, including at least one of a title, a body text, a summary, a publication time, a uniform resource locator, or a source identifier.

The term “normalize” refers to processing that converts heterogeneous article information from multiple information sources into a unified internal representation, including at least one of format conversion, field mapping, character encoding normalization, or removal of markup elements.

The term “structured data” refers to normalized article information represented in a predefined schema, such as a record, a table, or a hierarchical data object, in which attributes such as title, body text, and metadata are explicitly defined.

The term “natural language processing” refers to computational techniques that analyze and manipulate human language text, including at least one of tokenization, sentence segmentation, part-of-speech tagging, named entity recognition, semantic analysis, importance scoring, or summarization.

The term “importance scoring” refers to processing that assigns a numerical or categorical relevance value to a text unit, such as a sentence or a paragraph, based on features of the text unit and its relation to the information acquisition conditions.

The term “summarization” refers to processing that selects or generates a reduced-length representation of article information, such that the reduced-length representation preserves main points or key information relevant to a topic.

The term “topic-based summary information” refers to summary information that is grouped or organized according to at least one topic determined from the information acquisition conditions or from analysis of the article information.

The term “generative AI model” refers to a trained machine learning model that produces natural-language text in response to an input, such as a prompt sentence, and that is capable of generating coherent and contextually appropriate text, including but not limited to a large language model.

The term “prompt sentence for a generative AI model” refers to a natural-language instruction string constructed by the processor, including at least the topic-based summary information and the audio content specifications, which guides the generative AI model to generate an audio content script.

The term “audio content script” refers to a natural-language text output by the generative AI model that is arranged in a form suitable to be spoken as audio, including at least an introduction, one or more segments, transitions, and a closing portion.

The term “text correction” refers to processing that modifies text to improve at least one of grammar, spelling, style, consistency, or safety, based on predetermined rules or additional language analysis.

The term “segment division” refers to processing that divides a script into smaller text units, such as paragraphs or sections, suitable for separate handling by speech synthesis, including insertion of boundaries for pauses or changes in emphasis.

The term “text data for speech synthesis” refers to processed script text that is formatted and segmented in a manner appropriate for use by a speech synthesis engine, possibly including markup elements indicating pauses, emphasis, or prosody.

The term “speech synthesis technology” refers to computational techniques and engines that convert text data into audio waveforms representing spoken language, including neural network-based text-to-speech techniques.

The term “audio data” refers to digital data representing sound, especially speech generated from text data by speech synthesis technology, and including encoded formats such as waveform data or compressed audio files.

The term “speaker characteristics” refers to controllable attributes of synthesized speech, including at least one of voice identity, pitch, speaking rate, timbre, accent, or language.

The term “playback time” refers to a temporal characteristic of audio data, including total duration and distribution of timing within the audio content, which may be adjusted to approximate a desired listening length specified in the audio content specifications.

The term “media distribution format” refers to a data structure and encoding scheme for distributing audio content, including at least one of a file format, a container format, a streaming protocol, or a metadata format suitable for media applications.

The term “metadata” refers to auxiliary information associated with audio data, including at least one of a title, a description, a publication date, a duration, an identifier, a resource locator, or classification tags.

The term “distribution information” refers to information maintained by the server that defines how audio data in a media distribution format is made available to terminals, including at least pointers to stored files, metadata entries, and status indicators.

The term “terminal” refers to an end-user device that communicates with the server over the communication network, including at least one of a mobile device, a personal computing device, or a media playback device, and that is capable of receiving and reproducing audio data.

The term “usage mode indicating visual acquisition difficulty” refers to a specification contained in or derived from the prompt sentence that indicates a user preference or requirement for enhanced auditory presentation due to limited ability to obtain information visually.

The term “emphasis section” refers to a portion of audio data or corresponding text that is designated to be rendered with modified prosody, such as increased loudness, altered pitch, or extended duration, to highlight its importance during auditory presentation.

In one embodiment, a server implements the claimed system as a network-accessible platform that generates audio content based on a prompt sentence supplied by a user. The server includes at least one hardware processor, a main memory, a non-volatile storage device, a network interface, and optionally a hardware accelerator such as a graphics processing unit. The server executes an operating system, such as a general-purpose server operating system, and application software implemented, for example, in a programming language that supports networking, text processing, and machine learning libraries. The server communicates with a terminal operated by the user through a communication network. The terminal is, for example, a mobile device, a personal computing device, or another network-enabled apparatus that presents a user interface and reproduces audio.

The user operates the terminal to input a prompt sentence. The terminal executes an application or a browser-based client that displays a text input area and transmits the user's input to the server over the communication network using a communication protocol such as HTTPS. The user may input a prompt sentence such as:
“Collect the latest AI technology news and create a 10-minute podcast script that is easy for beginners to understand.”
“Collect regional startup news in Tokyo and create a 5-minute podcast script in Japanese.”
“Summarize today's main global economic news and create a 15-minute podcast script in a professional anchor style.”

The terminal formats the input as a text payload and sends it to an application programming interface endpoint provided by the server. The terminal may additionally transmit optional parameters such as user identifiers or language preferences, but in a basic embodiment, the prompt sentence alone is sufficient for the server to extract processing conditions.

The server receives the prompt sentence via the network interface. The server stores the prompt sentence and related metadata, such as a timestamp and a terminal identifier, in a storage device that may be realized as a relational database management system or a document-oriented data store. The server applies natural language processing to the prompt sentence by executing, for example, a tokenization module, a part-of-speech tagger, and a semantic role labeling component. In one concrete implementation, the server uses a statistical or neural language processing library to segment the prompt sentence into tokens, identify content words that correspond to topics (for example “AI technology news”), detect numerical expressions that indicate duration (for example “10-minute”), and detect phrases that describe style or target audience (for example “easy for beginners to understand”).

The server converts the result of this analysis into information acquisition conditions and audio content specifications. The server represents these as structured objects, for example as records containing fields such as “topic_terms”, “time_range”, “language”, “desired_duration_minutes”, “target_audience_level”, and “narrative_style”. The server maps linguistic patterns in the prompt sentence to these fields using a combination of pattern matching and learned classification models. This conversion into structured data constitutes a technical improvement in that it allows downstream modules to operate on explicitly defined, machine-readable parameters, which reduces ambiguity and avoids repeated parsing of raw natural language.

The server uses the information acquisition conditions to obtain article information from multiple information sources through the communication network. The server accesses, for example, external network services that provide news feeds, and web servers that publish text articles. The server employs a network access module that constructs query requests containing topic terms and time range constraints. The server uses an HTTP client library to send these requests and receive responses encoded in structured formats, such as structured text or hierarchical notation. The server may apply rate limiting, connection pooling, and caching strategies to reduce communication overhead and improve throughput.

The server normalizes heterogeneous article information obtained from different information sources into a unified internal representation. For example, the server maps each article to a record that contains standardized fields such as “title”, “body_text”, “published_at”, “source_identifier”, and “language_code”. The server removes markup tags from body_text fields, converts character encodings to a single internal encoding, and standardizes date-time representations. The server may store these normalized records in a columnar database or in an in-memory data structure optimized for sequential processing. By enforcing a common schema at this stage, the server reduces the cost of later processing and avoids repeated ad-hoc conversions, thereby improving data management efficiency and processing speed.

The server applies natural language processing to the structured data to generate topic-based summary information. The server first divides the body_text of each article into sentences using a sentence boundary detection algorithm that considers punctuation and language-specific rules. The server represents each sentence as a vector of features that may include term frequency-inverse document frequency values, position within the article, presence of named entities related to the topic, and contextual embeddings generated by a neural language representation model. The server calculates an importance score for each sentence based on a weighted combination of these features. In one embodiment, the server employs a TextRank-like graph algorithm, in which sentences are nodes and edges represent similarity values computed from vector distances. The server iteratively updates importance scores using a convergence process analogous to PageRank, which yields a ranked list of sentences for each article.

The server selects top-ranked sentences for each article and concatenates them to form article-level summaries, while enforcing constraints on total length and redundancy. The server then performs clustering of article-level summaries by computing vector representations for each summary using, for example, a transformer-based encoder. The server applies a clustering algorithm such as k-means or hierarchical clustering on these vectors to group articles into topic clusters that correspond to subtopics within the broader subject indicated by the information acquisition conditions. For each cluster, the server generates a cluster-level summary by combining the article-level summaries with additional compression, such as another round of extractive summarization or an abstractive summarization model.

The server constructs topic-based summary information as a structured object that includes multiple sections. Each section may have a heading representing a subtopic, a condensed textual description of key points, and references to the underlying articles. The server stores this summary information in a memory area from which it can be retrieved for subsequent processing. This multi-stage summarization and clustering procedure yields a compact representation that retains diversity in viewpoints while removing redundant content, which reduces the size of the data passed to later modules and thus reduces memory consumption and improves response time.

The server uses the topic-based summary information and the audio content specifications to construct a prompt sentence for a generative AI model. The server concatenates a system instruction part, a user instruction part, and the summarized content into a single string. For example, the server may construct a prompt having a system instruction such as “You are a podcast script writer who explains complex topics for beginners,” followed by explicit constraints like “Create a script of approximately 10 minutes” and “Use a friendly and clear style,” and then append the topic-based summary information. The server ensures that the constructed prompt obeys a token limit compatible with the generative AI model by applying additional compression or truncation if needed.

The server transmits the constructed prompt sentence to the generative AI model. The generative AI model, in one embodiment, is a neural network-based large language model deployed as an inference service. The model may follow a transformer architecture that includes multiple self-attention layers, feed-forward layers, and positional encodings. The model has been pre-trained on large-scale text corpora using a language modeling objective in which the model minimizes a loss function, such as cross-entropy between predicted token probabilities and actual tokens. During training, weights in the transformer layers are updated by backpropagation and gradient-based optimization, such as stochastic gradient descent or adaptive methods. In some embodiments, the model is fine-tuned on conversational and instruction-following data so that it better responds to structured prompts that include instructions and content.

The server sends the input tokens, representing the constructed prompt sentence, to the generative AI model and receives output tokens that form the audio content script. The server may set hyperparameters for the generation process, such as temperature, top-k, or nucleus sampling thresholds, to control diversity and determinism. The server reconstructs the audio content script as a text string from the received tokens. The script typically contains an introduction, one or more segments corresponding to different subtopics, transitions between segments, and a conclusion.

The server applies text correction and segment division to the generated script. For text correction, the server executes language analysis modules that include grammar checking and style normalization. These modules can be implemented by additional language models or by rule-based systems that operate on part-of-speech tags and dependency trees. The server corrects broken sentences, removes repeated phrases, and enforces consistent terminology for key technical terms. For segment division, the server identifies boundaries between logical sections using indicators such as discourse markers, heading-like phrases, or abrupt topic shifts. The server inserts segmentation markers and, optionally, markup tags that will be used by a speech synthesis engine to control pauses and emphasis. For instance, the server may wrap important phrases with emphasis tags and insert break tags of specified durations between segments. By carrying out segment division and markup insertion, the server reduces the likelihood of overly long synthesis requests and enables more precise control of prosody, which improves intelligibility.

The server converts the text data for speech synthesis into audio data using speech synthesis technology. The server may use a neural text-to-speech engine, such as a sequence-to-sequence model with attention or a network that generates spectrograms followed by a vocoder that converts spectrograms to waveforms. Such models are typically trained to minimize a reconstruction loss between predicted audio features and ground-truth features, and may also use adversarial training to improve naturalness. The server passes the segmented text and markup tags to the speech synthesis engine along with parameters that specify speaker characteristics, such as voice identity, pitch, and speaking rate. The server may select different speaker profiles depending on the audio content specifications in the original prompt sentence, for example choosing a slower, clearer voice for beginners.

The server adjusts playback time of the audio data in accordance with the desired duration expressed in the audio content specifications. The server calculates an estimated duration based on the length of the text segments and the speaking rate and may adapt speaking rate or insert or remove pauses to approximate the target duration without significantly degrading intelligibility. When the prompt sentence indicates a usage mode associated with visual acquisition difficulty, the server further adjusts playback speed to be slower, increases pause durations at sentence boundaries, and increases emphasis on important terms or phrases. This adjustment is applied by modifying input parameters of the text-to-speech engine or by post-processing audio waveforms using time-stretching algorithms that preserve pitch.

The server stores the generated audio data as a file in a media distribution format. The server may encode the waveform into a compressed audio format. The server creates metadata that includes at least a title, a short description, a duration value, a creation time, an identifier, and a resource locator that points to the stored audio file. The server registers these metadata in a catalog or updates a feed description structure that can be accessed by terminals. The server configures a storage system or a content delivery network so that the audio file can be accessed via a uniform resource locator.

The server exposes an interface for terminals to request available audio content. The terminal retrieves a list of available episodes or audio objects, selects an entry based on user interaction, and requests the associated audio resource. The terminal receives the audio data and reproduces the sound through a speaker or a headset. The user listens to the audio content. The user may, after listening, provide another prompt sentence that refines the topic, the duration, or the style, and the server repeats the described processes. Because the server maintains a structured representation of previous prompt sentences and corresponding conditions, the server can reuse cached article information and summary information for similar requests, which reduces network traffic and processing overhead.

The described architecture provides several technical effects beyond mere automation of human tasks. By converting a natural-language prompt sentence into structured information acquisition conditions and audio content specifications, the server reduces redundant parsing and enables deterministic control of downstream modules, which improves computational efficiency. The server's normalization and clustering of article information reduce the number of items that must be processed by the generative AI model and the speech synthesis engine, which cuts computational load and network latency. The multi-stage summarization pipeline, including importance scoring and clustering, reduces noise and redundancy in the input to the generative AI model, thereby improving the accuracy and relevance of generated scripts.

The integration of a transformer-based generative AI model with explicit prompt construction and subsequent text correction and segmentation yields scripts that are more coherent and better tailored to device constraints and user conditions than scripts produced by simpler rule-based systems. The server's dynamic control over speaker characteristics, playback speed, pauses, and emphasis, based on metadata derived from the prompt sentence and usage mode, improves accessibility and reduces cognitive load for users with visual acquisition difficulty. Overall, the server improves the technical field of computer-implemented audio content generation by optimizing data structures, processing order, and model usage, resulting in faster response times, lower error rates, and better resource utilization.

In alternative embodiments, the server may host the generative AI model locally rather than calling an external service, in which case the server executes inference using local accelerators and can adjust internal model parameters or decoding algorithms to meet latency constraints. In another embodiment, the server may employ different summarization algorithms, such as supervised summarization models trained on domain-specific corpora, while still constructing prompt sentences and generating audio content as described. In yet another embodiment, the server may support multiple languages by storing language-specific normalization rules and speech synthesis voices, and may dynamically select them based on language codes extracted from the prompt sentence. These variations share the common feature that the server performs structured extraction of conditions from a prompt sentence, normalized processing of multi-source article information, coordinated use of natural language processing and a generative AI model, and controlled speech synthesis to produce audio content that is efficiently generated and technically optimized for distribution and playback.

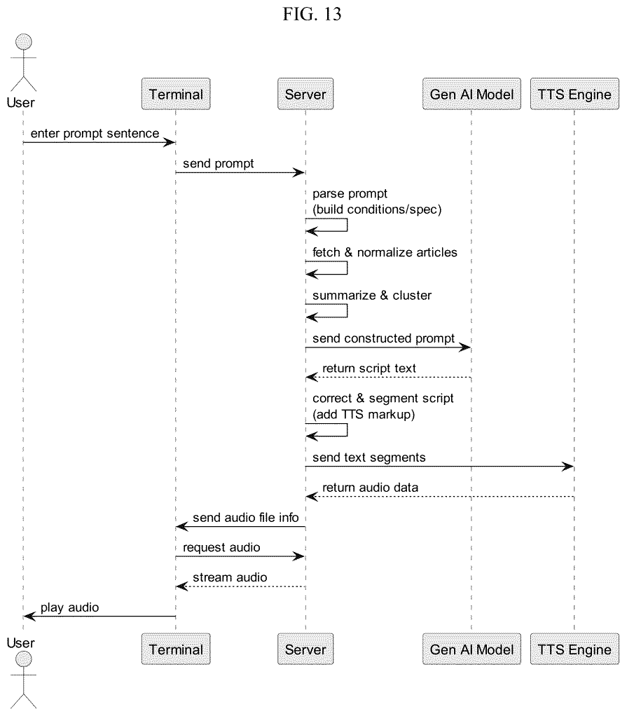

The following describes the processing flow using FIG. 13.
Step 1:

The user operates the terminal to input a prompt sentence.

The input of Step 1 is an empty input field displayed by the terminal.

The terminal displays a text input area and optionally preset examples such as:
“Collect the latest AI technology news and create a 10-minute podcast script that is easy for beginners to understand.”

The user types a prompt sentence into the input area and confirms the input.

The output of Step 1 is a text string representing the prompt sentence held in the terminal's memory.
Step 2:

The terminal transmits the prompt sentence to the server.

The input of Step 2 is the prompt sentence text string obtained in Step 1.

The terminal encapsulates the prompt sentence in a request message, attaches optional parameters such as a language code or user identifier, and sends the message to the server via a network protocol.

The terminal performs basic validation, such as checking that the prompt sentence is not empty and that its length is within a predefined limit, and then issues a network request.

The output of Step 2 is a network packet containing the prompt sentence that is received at the server.
Step 3:

The server stores and parses the prompt sentence.

The input of Step 3 is the prompt sentence received from the terminal.

The server writes the raw prompt sentence and reception timestamp to a storage device and then applies a natural language processing module to segment the prompt into tokens, identify part-of-speech tags, and detect named entities and numerical expressions.

The server computes syntactic and semantic features from these tokens, such as dependency relations and phrase boundaries, and creates internal feature representations.

The output of Step 3 is a set of parsed structures, including token lists, linguistic tags, and extracted phrase segments associated with the original prompt sentence.
Step 4:

The server derives information acquisition conditions from the parsed structures.

The input of Step 4 is the parsed representation of the prompt sentence produced in Step 3.

The server applies rule-based mappings and classification models to the parsed structures to detect topic terms, time ranges, geographic indications, language preferences, and quantity constraints.

The server converts these detections into a structured object representing information acquisition conditions, by filling fields such as topic_terms, time_window, language_code, and max_articles.

The output of Step 4 is an information acquisition condition object stored in memory.
Step 5:

The server derives audio content specifications from the parsed structures.

The input of Step 5 is the same parsed representation of the prompt sentence produced in Step 3.

The server analyzes style-related phrases and numeric duration expressions and maps them to fields such as desired_duration_minutes, narrative_style, target_audience_level, and accessibility_mode.

The server may use a classifier to map phrases like “easy for beginners to understand” to a beginner-level audience and to a friendly narrative style.

The output of Step 5 is an audio content specification object associated with the prompt sentence.
Step 6:

The server generates query parameters for external information sources.

The input of Step 6 is the information acquisition condition object from Step 4.

The server selects topic terms, time ranges, and language codes and converts them into query strings and parameter sets compliant with external information source interfaces.

The server builds one or more query parameter sets, each specifying fields such as “q”, “from_date”, “to_date”, “language”, and “page_size”.

The output of Step 6 is a list of query parameter sets that are ready to be sent to external information sources.
Step 7:

The server retrieves article information from multiple information sources.

The input of Step 7 is the list of query parameter sets generated in Step 6.

The server iterates over each parameter set, sends network requests to corresponding information sources, receives responses containing article data, and decodes the responses into intermediate data structures.

The server merges responses from different information sources and may discard malformed or incomplete entries during this merge.

The output of Step 7 is a raw article collection that contains heterogeneous article records from multiple sources.
Step 8:

The server normalizes the raw article collection into structured data.

The input of Step 8 is the raw article collection obtained in Step 7.

The server applies normalization rules to map source-specific fields to a unified schema, converts all text encodings to a common encoding, strips markup tags from article bodies, and standardizes timestamps to a consistent time zone and format.

The server constructs a structured record for each article, containing fields such as title, body_text, published_at, source_identifier, and language_code.

The output of Step 8 is a normalized article dataset stored as structured data in memory or a database.
Step 9:

The server filters and classifies the structured data based on relevance.

The input of Step 9 is the normalized article dataset from Step 8 and the information acquisition conditions from Step 4.

The server computes keyword frequencies, checks language codes, and applies a relevance classifier to each article to determine whether it matches the requested topic and constraints.

The server removes articles with low relevance scores or that fall outside the specified time range or language, and assigns topic labels or category tags to the remaining articles.

The output of Step 9 is a filtered and classified article subset with associated relevance scores.
Step 10:

The server performs sentence-level analysis on the filtered articles.

The input of Step 10 is the filtered and classified article subset from Step 9.

The server segments body_text of each article into sentences, tokenizes each sentence, and computes feature vectors such as term frequency-inverse document frequency, positional indices, and contextual embeddings.

The server stores these sentence units along with their feature vectors and article associations in an internal data structure.

The output of Step 10 is a sentence-level dataset with feature representations for each sentence.
Step 11:

The server calculates importance scores for sentences.

The input of Step 11 is the sentence-level dataset from Step 10 and the topic terms from the information acquisition conditions.

The server constructs a similarity graph of sentences based on feature vector distances and applies an importance ranking algorithm, such as a graph-based ranking procedure, to propagate importance values among connected sentences.

The server combines graph-based scores with topic similarity features to compute a final importance score for each sentence.

The output of Step 11 is a set of sentences each annotated with an importance score.
Step 12:

The server generates article-level summaries using the importance scores.

The input of Step 12 is the set of sentences with importance scores from Step 11 and the article associations of these sentences.

The server sorts sentences for each article by importance score, selects top-ranked sentences within a target word or character budget, and orders them according to original article sequence.

The server concatenates selected sentences to form a concise summary for each article.

The output of Step 12 is a list of article-level summaries corresponding to the filtered articles.
Step 13:

The server clusters article-level summaries into topic groups.

The input of Step 13 is the list of article-level summaries produced in Step 12.

The server computes embedding vectors for each summary using a language representation model and then applies a clustering algorithm to group summaries based on vector similarity.

The server assigns a cluster identifier to each summary and constructs groups of related summaries that represent subtopics within the overall topic.

The output of Step 13 is a set of topic groups, each containing one or more article-level summaries and their cluster identifiers.
Step 14:

The server creates topic-based summary information from the topic groups.

The input of Step 14 is the set of topic groups from Step 13.

The server, for each group, selects important sentences across all member summaries, optionally performs an additional compression step, and generates a condensed text section that represents the key points of that group.

The server constructs a structured object containing multiple sections, each with a heading, a condensed description, and references to original articles.

The output of Step 14 is topic-based summary information ready for use in prompt construction.
Step 15:

The server constructs a prompt sentence for a generative AI model using the topic-based summary information and audio content specifications.

The input of Step 15 is the topic-based summary information from Step 14 and the audio content specification object from Step 5.

The server generates a system instruction string describing the role of the generative AI model, appends explicit constraints on duration, style, and target audience, and then appends the topic-based summary information as content material.

The server concatenates these elements into a single textual prompt string, and if necessary, truncates or compresses less important parts to satisfy a maximum token length constraint.

The output of Step 15 is a constructed prompt sentence for the generative AI model.
Step 16:

The server requests an audio content script from the generative AI model.

The input of Step 16 is the constructed prompt sentence from Step 15.

The server encodes the prompt sentence into tokens, sets generation parameters such as maximum length, temperature, and sampling strategy, and sends these tokens to the generative AI model via an interface.

The server receives generated tokens from the model, decodes them into text, and reconstructs a complete script.

The output of Step 16 is an audio content script in natural language text form.
Step 17:

The server applies text correction to the audio content script.

The input of Step 17 is the audio content script produced in Step 16.

The server uses language analysis tools to detect grammatical errors, inconsistent terminology, and duplicated phrases, and then applies correction rules or secondary language models to modify the script.

The server outputs a revised script that maintains the original structure but improves correctness and readability.

The output of Step 17 is a corrected audio content script.
Step 18:

The server divides the corrected script into segments and adds markup for speech synthesis.

The input of Step 18 is the corrected audio content script from Step 17 and the audio content specifications from Step 5.

The server identifies boundaries for introduction, individual topic sections, transitions, and conclusion, and inserts segment delimiters at these boundaries.

The server adds prosody markup, including pause indicators and emphasis tags, based on sentence importance and accessibility requirements, such as slow playback and longer pauses for certain users.

The output of Step 18 is text data for speech synthesis, including segmented text and associated markup tags.
Step 19:

The server generates audio data from the text data for speech synthesis.

The input of Step 19 is the text data for speech synthesis from Step 18 and parameters specifying speaker characteristics and desired playback time.

The server sends each text segment and its markup to a text-to-speech engine, receives audio waveforms for each segment, and, if needed, applies time-stretching or rate control to match the target duration.

The server concatenates segment waveforms in the correct order and performs audio post-processing, such as volume normalization and encoding into a compressed format.

The output of Step 19 is a complete audio file representing the audio content.
Step 20:

The server stores the audio file and generates media distribution metadata.

The input of Step 20 is the audio file from Step 19 and associated information such as title, description, and duration derived from the script and audio content specifications.

The server writes the audio file to a storage system, generates a unique resource locator, and creates metadata including an identifier, title, summary, duration, and file location.

The server registers this metadata in a catalog or feed structure that can be accessed by terminals.

The output of Step 20 is a stored audio file and an updated metadata record ready for distribution.
Step 21:

The terminal retrieves metadata and accesses the audio content.

The input of Step 21 is a user action on the terminal indicating a request for available audio content and the metadata record stored on the server.

The terminal requests a list of available audio items, receives metadata including titles and resource locators, and displays the list to the user.

The user selects a desired item, and the terminal requests the corresponding audio file from the server or associated storage service.

The output of Step 21 is the audio file streamed or downloaded to the terminal.
Step 22:

The terminal plays the audio content for the user.

The input of Step 22 is the audio file received in Step 21.

The terminal decodes the audio data, sends it to an audio output device such as a speaker or headset, and controls playback according to user commands such as play, pause, or seek.

The user listens to the generated audio content and, if desired, may formulate a new prompt sentence based on the experience.

The output of Step 22 is an auditory presentation of the content to the user, and optionally a new prompt sentence that can initiate another processing sequence.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional audio information delivery systems generally transform static text content into audio streams without deeply integrating user-specific contextual information such as long-term interests, real-time emotional state, or historical reactions to prior content. In typical architectures, a processor merely retrieves content, performs straightforward text-to-speech conversion, and forwards the resulting audio to a terminal. Such systems treat all users, sessions, and emotional contexts in substantially the same manner. As a result, these systems suffer from limited personalization, reduced user engagement, and inefficient use of network and computation resources because users frequently skip or abandon content that does not match their interests or current cognitive/emotional state.

Furthermore, existing generative artificial intelligence models are commonly used in a stateless or weakly contextualized fashion: a client or server sends a generic prompt sentence, receives generated text, and uses it as is. There is typically no systematic mechanism in the underlying computer system to (i) construct prompt sentences from structured multi-source data (including interest information, emotion information, and multi-document summaries), (ii) continuously update prompt-generation conditions based on logged user reactions and emotion data, and (iii) couple such updated prompt-generation with downstream audio synthesis and playback control parameters such as playback speed, volume, and background sound. Consequently, the processor does not fully exploit the generative artificial intelligence model as a dynamic component of a personalized, closed-loop media pipeline.

Additionally, conventional text-to-speech based audio systems do not sufficiently address accessibility in visually constrained scenarios in a technically integrated way. While audio output itself can aid users who cannot easily consume visual information, known systems typically do not adapt search conditions, summarization behavior, or audio rendering parameters based on learned relationships between a user's emotional reaction history and prior audio deliveries. Thus, the underlying computer technology remains suboptimal in terms of (a) how it encodes heterogeneous inputs (search results, history, emotion), (b) how it configures generative artificial intelligence through prompt sentences, and (c) how it closes the loop by learning from user reactions to improve future computational behavior.

Accordingly, there is a need for an improved computer-implemented system in which a processor (1) generates search information on the basis of user request information, (2) analyzes related information together with past use history information to derive user-specific interest information and emotion information, (3) generates a prompt sentence that instructs a generative artificial intelligence model to produce explanation information for audio, (4) controls text-to-speech conversion and playback parameters based on the emotion information, and (5) learns, via machine learning, conditions for generating search information, conditions for generating prompt sentences, and conditions for adjusting audio playback parameters, all in an integrated processing pipeline. Such a system would improve the operation of the computer itself by enabling more efficient content selection, reducing unnecessary data transfers, and enhancing the effectiveness of generative artificial intelligence usage for audio media generation.

The specific processing by the specific processing unit 290 of the data processing device 12 in Application Example 2 is realized by the following means.

The present invention provides a server comprising a processor configured to receive request information from a user via a terminal device and generate search information for acquiring related information from an information network on the basis of the request information; to analyze the related information and past use history information stored in a storage device to generate interest information and emotion information of the user and to generate analysis information obtained by summarizing the related information; to generate, on the basis of the analysis information and the interest information and the emotion information, a prompt sentence for instructing a generative artificial intelligence model to generate explanation information for audio; to transmit the prompt sentence to the generative artificial intelligence model through a communication interface and obtain the explanation information for audio generated by the generative artificial intelligence model; to execute speech synthesis processing on the explanation information for audio to generate audio data and to adjust at least one of a playback speed, a volume, and a background sound of the audio data in accordance with the emotion information; to distribute the adjusted audio data to the terminal device via the communication interface; and to update, by executing machine learning processing on reaction information and emotion information of the user received from the terminal device, at least one of the interest information, conditions for generating the search information, and conditions for generating the prompt sentence so that subsequent processing is optimized for the user. This enables the computer system to dynamically configure the generative artificial intelligence model by context-rich prompt sentences and to iteratively refine retrieval, generation, and audio rendering behaviors based on learned user reactions, thereby improving computational efficiency, personalization accuracy, and accessibility in audio information delivery beyond that achievable with conventional static text-to-speech systems.

The term “request information” refers to information indicating a desire of a user to obtain content, including at least one of a keyword, a natural language query, a topic selection, or category selection input via a terminal device.

The term “search information” refers to information used by the processor to acquire related information from an information network, including at least one of a search query string, a set of search parameters, or a request to an external information source.

The term “related information” refers to information obtained from an information source on the basis of search information, including at least one of text data, metadata, or media data related to the user's request information.

The term “information network” refers to a communication network through which the processor acquires related information, including at least one of a wide area network, a local area network, or the Internet.

The term “past use history information” refers to information indicating historical interactions of a user with the system, including at least one of previously consumed content, playback durations, skip events, feedback operations, or previously detected emotion information.

The term “interest information” refers to information representing preferences of a user regarding content, including at least one of preferred topics, categories, styles, or lengths inferred from request information and past use history information.

The term “emotion information” refers to information indicating an emotional state of a user, including at least one of a label, a score, or a probability distribution representing emotions such as joy, sadness, relaxation, or concentration, obtained by emotion analysis processing.

The term “analysis information” refers to information generated by the processor by processing related information, including at least one of a summary, an extracted key point set, or a structured representation of the related information.

The term “prompt sentence” refers to natural language information provided to a generative artificial intelligence model to instruct the generative artificial intelligence model to perform generation processing, including at least one of an instruction, a description of context, or constraints for generating explanation information for audio.

The term “generative artificial intelligence model” refers to a data processing model that receives a prompt sentence and generates text or other structured output by probabilistic or machine learning based processing, including at least a language model implementing generative processing.

The term “explanation information for audio” refers to text information generated by the generative artificial intelligence model in response to a prompt sentence and intended to be converted into audio, including at least one of a script, a narration, or a commentary.

The term “speech synthesis processing” refers to processing that converts text information into audio data by using voice generation algorithms, including at least one of waveform generation, phoneme synthesis, or prosody control.

The term “audio data” refers to digital data representing sound, including at least one of sampled waveform data, encoded audio frames, or files in a predetermined audio format.

The term “playback speed” refers to a parameter controlling a temporal rate at which audio data is reproduced, including at least one of a normal rate, an increased rate, or a decreased rate relative to a reference speed.

The term “volume” refers to a parameter controlling an amplitude level of audio output during playback of audio data, including at least one of a gain value, a loudness level, or a relative sound pressure level.

The term “background sound” refers to sound mixed with a main narration in audio data, including at least one of background music, ambient noise, or sound effects.

The term “terminal device” refers to an information processing device used by a user to interact with the system, including at least one of a smartphone, a tablet device, a personal computer, or a wearable device.

The term “communication interface” refers to a hardware or software interface for transmitting and receiving information between the processor and external devices or networks, including at least one of a wired interface, a wireless interface, or a network protocol stack.

The term “reaction information” refers to information indicating a response of a user to provided audio data, including at least one of playback duration, skip operations, replay operations, rating operations, or explicit feedback inputs.

The term “state information” refers to information representing a physical or behavioral state of a user, including at least one of image data of a face, audio data of a voice, or biometric sensor data.

The term “imaging device” refers to a device that captures image data, including at least one of a camera, an image sensor, or a video capture module.

The term “acoustic acquisition device” refers to a device that captures audio data, including at least one of a microphone or an audio input module.

The term “emotion analysis processing” refers to processing that estimates an emotional state of a user on the basis of state information, including at least one of facial expression analysis, voice tone analysis, or multimodal emotion recognition.

The term “style information” refers to information specifying a manner of expression in generated text, including at least one of tone, politeness level, formality level, or narrative style.

The term “content structure information” refers to information specifying an organization of generated text, including at least one of a section order, a heading configuration, or a segmentation into introduction, main body, and conclusion.

The term “machine learning processing” refers to processing in which parameters of a model are updated on the basis of data so that prediction or classification performance with respect to a target variable is improved, including at least one of supervised learning, unsupervised learning, or reinforcement learning.

In one embodiment, a server, a terminal, and a user cooperate to implement the claimed system. The server includes at least one processor, a main memory, a non-volatile storage device, and a communication interface. The terminal includes at least one processor, a memory, a display device, an imaging device, an acoustic acquisition device, an audio output device, and a communication interface. The user operates the terminal to interact with the server.

The server executes a program stored in the non-volatile storage device. The program is implemented, for example, in a high-level language such as a scripting language or a compiled language, and runs on an operating system. The server program is composed of multiple software modules, including a request reception module, a search information generation module, a related information acquisition module, a natural language processing module, a user modeling module, a prompt sentence generation module, a generative AI interface module, a speech synthesis interface module, an audio adjustment module, a reaction logging module, and a machine learning module.

The terminal executes an application program stored in a local storage unit. The terminal program includes a user interface module, an emotion acquisition module, a communication module, and a media playback module. The user operates the terminal program by performing operations such as entering a query, selecting categories, and providing feedback.

### Server Hardware and Software

The server comprises a multi-core processor configured to execute concurrent threads for input/output processing, natural language processing, and machine learning. The server uses a database system, such as a relational database or a key-value store, to store past use history information, interest information, emotion information, and reaction information. The server uses a network stack implementing a transport protocol and a secure session protocol to communicate with the terminal and external information sources.

The server uses a natural language processing library, such as a general-purpose tokenizer and parser, to perform sentence segmentation, tokenization, part-of-speech tagging, named entity recognition, and key phrase extraction. The server uses a generative AI model in the form of a neural network language model, accessed either as a remote service through an application programming interface or as a local model executed on the server. The server uses a speech synthesis engine, such as a parametric or neural text-to-speech engine, accessed through an application programming interface. The server uses an audio processing library to adjust audio parameters, to mix background sound, and to normalize volume.

### Terminal Hardware and Software

The terminal comprises an imaging device such as a front-facing camera, an acoustic acquisition device such as a microphone, a display panel, an audio output device such as a speaker or a headphone jack, and one or more sensors. The terminal executes an application providing a graphical user interface for entering text queries, selecting topics, and controlling playback.

The terminal uses an emotion analysis library or a remote emotion analysis service to estimate emotion information from state information. The terminal captures still images or video frames of the user's face and records audio of the user's voice. The terminal converts the captured state information into feature vectors, such as facial landmark coordinates, facial action units, or spectral features of the voice. The terminal provides the feature vectors to the emotion analysis processing, which outputs emotion information such as “joy,” “sadness,” “relaxation,” or “concentration” with associated confidence scores.

### Generation of Search Information and Related Information

The server receives request information from the terminal via the communication interface. The server generates search information by mapping the request information into one or more search queries and associated parameters. For example, when the user enters “I want positive news about environmental technology,” the server generates search information that includes a query term string “environmental technology,” a filter indicating “recent” articles, and a polarity preference “positive.”

The server sends the search information to one or more external information sources, such as news feeds or web indexes, by constructing HTTP requests. The server receives related information in the form of structured or semi-structured data, for example, documents containing titles, body text, publication dates, and source identifiers. The server stores the related information temporarily in main memory and may also store references in the database.

### Natural Language Processing and Generation of Analysis Information

The server applies the natural language processing module to the related information. The server normalizes the text by removing markup, converting to a canonical encoding, and optionally performing lowercasing while preserving proper nouns for named entity recognition. The server segments the text into sentences and words, assigns part-of-speech tags, and identifies named entities such as organizations, locations, and person names.

The server then generates analysis information by summarizing and structuring the related information. The server may compute sentence importance scores based on term frequency, inverse document frequency, and positional features, and select top-ranked sentences as summary candidates. The server may also cluster sentences into topics using a similarity measure on sentence embeddings produced by a pre-trained embedding model. The result of this processing is analysis information including: a list of extracted key sentences, a list of key phrases, topic clusters, and a structured representation of the content.

### User Modeling and Generation of Interest Information and Emotion Information

The server accesses past use history information stored in the database. The server maintains, for each user, data structures such as a topic preference vector, a style preference vector, and a session log of reactions and emotion information. The server updates the topic preference vector by incrementing weights associated with topics that have been listened to for a long duration and that coincided with positive emotion labels. The server decreases weights for topics that are frequently skipped or associated with negative emotion labels.

The server generates interest information as a probability distribution over topics, styles, and lengths. The server also generates emotion information for the current request by combining the emotion information sent from the terminal with historical emotion patterns. For example, when the terminal reports “joy” and historical data indicates that “environment” news often leads to “joy,” the server increases the weight of environment topics.

### Generation of the Prompt Sentence

The server constructs a prompt sentence in natural language for the generative AI model. The prompt sentence is generated by combining analysis information, interest information, and emotion information into a text template. The server encodes the desired length, tone, structure, and audience in the prompt sentence. For example, the server may generate the following prompt sentence:
“You are a podcast script writer. The listener is interested in positive news about environmental technology and is currently in a joyful mood. Using the following article summaries, create a 6-minute podcast script in English with a hopeful and friendly tone, suitable for listening while commuting. Include an introduction, two main segments, and a short closing. Article summaries: [summary text].”

In another example, when the user is relaxed and requests technology and environmental issues, the server may generate:
“You are a podcast script writer. The listener is interested in technology and environmental issues and wants to relax. Using the following article summaries, create a 10-minute podcast script in a calm and reassuring tone. Provide an introduction, three clearly separated sections, short pauses between sections, and a closing that gently summarizes the key points.”

The server logs the prompt sentence and associated metadata in the database, enabling later analysis and training.

### Generative AI Model Architecture and Operation

The generative AI model is implemented as a multi-layer neural network language model. The model includes an embedding layer that maps tokens of the prompt sentence into dense vectors, a stack of attention-based layers that compute contextualized representations, and an output layer that predicts the next token in a sequence. The model is trained on large text corpora using a sequence-to-sequence or autoregressive training objective.

The model uses parameters including weight matrices and bias vectors in each layer. During training, the model minimizes a loss function such as cross-entropy between predicted token distributions and ground-truth tokens. The model updates the weights using gradient-based optimization, such as stochastic gradient descent with momentum or an adaptive optimizer. The training process may also use techniques such as dropout, layer normalization, and positional encoding.

In deployment, the server sends the prompt sentence to the generative AI model through the generative AI interface module. The model encodes the prompt sentence and iteratively generates tokens until a stopping condition is met, such as a length limit or an end-of-sequence token. The server receives the generated text, which constitutes explanation information for audio. The explanation information is shaped by the structure and constraints specified in the prompt sentence, producing a podcast-style script matching the user's interests and emotional context.

### Speech Synthesis and Audio Adjustment

The server passes the explanation information for audio to the speech synthesis interface module. The server converts the explanation information into a format such as SSML, embedding prosody tags according to emotion information. For example, in a relaxed context, the server inserts tags specifying a slightly slower speaking rate and lower pitch in certain sections.

The server calls the speech synthesis engine with parameters such as language, voice type, speaking rate, and pitch. The engine generates audio data using either a parametric model or a neural vocoder that transforms spectrogram representations into waveforms. The server receives binary audio data and stores it in an audio file.

The server then applies the audio adjustment module. The server adjusts the playback speed by resampling or time-stretching the audio data within predetermined limits. The server adjusts the volume by applying a gain factor and may apply dynamic range compression to ensure consistent loudness. The server selects a background sound file according to emotion information, such as an energetic background for “joy” or a calm background for “relaxation,” and mixes it with the narration track while maintaining the narration intelligibility. The server normalizes the mixed audio to a target loudness level.

### Reaction Logging and Machine Learning

The terminal plays the audio data to the user. While the audio is being played, the terminal collects reaction information such as playback duration, skip events, replay events, and explicit feedback. The terminal also continues to capture state information from the imaging device and the acoustic acquisition device and to generate updated emotion information. The terminal periodically sends the reaction information and updated emotion information to the server.

The server stores these data in the database, indexed by user and session. The server uses the machine learning module to update parameters used in search information generation, prompt sentence generation, and audio adjustment. For example, the server maintains a model in which input features include topic frequencies, article source identifiers, prompt parameters, and emotion patterns, and output variables include engagement level or satisfaction scores. The server trains the model using supervised learning, minimizing an error function such as mean squared error between predicted and observed engagement metrics.

The server updates model parameters by gradient descent and may also perform data augmentation, such as adding noise to feature vectors or sampling different time windows of reaction data, to improve generalization. By using this learned model, the server adjusts future search information generation by biasing queries towards sources and topics that historically led to high engagement under similar emotion conditions. The server also adjusts templates for prompt sentences, for example, shortening scripts when the user often abandons long episodes, or emphasizing certain content structures that correlate with positive reactions.

### Technical Effect and Improvement of Computer Technology

The described configuration does not merely automate human editorial work. The server uses specific data structures for storing topic preferences, emotion histories, and reaction logs, and uses a feedback loop that modifies search generation, prompt generation, and audio rendering at the system level. This architecture reduces unnecessary network traffic by avoiding retrieval of content that is unlikely to match the learned user preferences. The server reduces computation load by limiting processing to top-ranked topics and sources determined by the learned model.

By generating prompt sentences that integrate summarized multi-document information, interest information, and emotion information, the server ensures that the generative AI model receives a compact, high-information context, which improves the relevance and coherence of generated scripts. This reduces the need for repeated generation calls and post-processing, improving processing speed and reducing resource consumption.

The use of machine learning to jointly optimize search conditions, prompt parameters, and audio adjustment parameters yields a lower error rate in matching content to user preferences and emotional states. The system thereby decreases the number of episodes that are quickly skipped, leading to more efficient use of storage and network bandwidth. In accessibility scenarios, where the user has difficulty obtaining visual information, the system improves the technical capability of the computing environment by automatically tuning speech rate, volume, and content structure to match the user's state, without requiring manual controls.

The server, terminal, and user cooperate within a technically specific framework: the terminal acquires state information via physical sensors, the server performs concrete numerical computations on structured data, and audio output is adjusted and delivered to a physical audio device. The result is a computer-implemented system whose internal operation—data structures, neural network models, machine learning loops, and signal processing—provides a technical improvement in how information is retrieved, processed, and rendered, beyond a mere implementation of an abstract idea or business method.

### Alternative Embodiments

In a variation, the generative AI model is executed locally on the server rather than accessed as a remote service. In this case, the server stores the model parameters in local storage and loads them into memory at startup. The server performs inference using a hardware accelerator such as a graphics processing unit or a tensor processing unit. The prompt sentence generation, explanation information generation, and speech synthesis interface remain as described, but data do not leave the server environment for generative processing.

In another embodiment, the server employs a different neural network architecture for the generative AI model, such as a recurrent neural network with attention or a convolutional sequence model. The training procedure still uses a loss function based on prediction error of token sequences and adjusts weights by back-propagation.

In yet another embodiment, the terminal performs certain parts of the processing, such as local generation of emotion information, partial summarization of related information, or local adjustment of playback speed and volume based on locally inferred emotion. The server still maintains the central logic for search information generation, prompt sentence generation, and machine learning based optimization.

In all embodiments, the server, the terminal, and the user interact within a framework in which a generative AI model and a prompt sentence are used as central technical components for dynamically generating, optimizing, and delivering audio content, while the computer system as a whole is improved in terms of efficiency, accuracy, and adaptability.

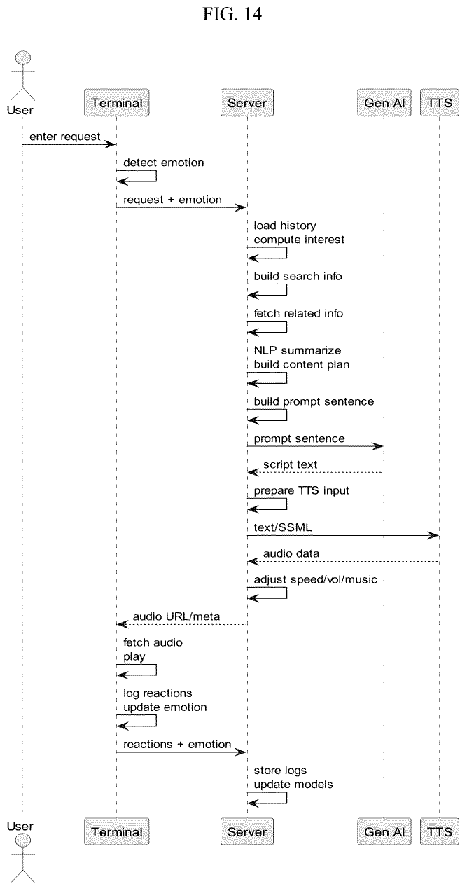

The following describes the processing flow using FIG. 14.
Step 1:

User operates the terminal to input request information.

User selects at least one topic or category on the terminal display, or enters a natural language query such as “I want positive news about environmental technology.” The input is text entered via a keyboard, tapping of category buttons, or speech captured by the microphone and converted to text by a speech-to-text module. The input is the raw request information. The output is a structured request object containing fields such as query text, selected categories, language, and user identifier. The terminal stores this object in memory and prepares it for transmission.
Step 2:

Terminal acquires state information and generates emotion information.

Terminal uses the imaging device to capture one or more images or video frames of the user's face and uses the acoustic acquisition device to capture a short segment of the user's voice. The input is raw image data and raw audio data. The terminal extracts feature vectors, such as facial landmarks, facial action units, and spectral features of the voice, by applying image processing and signal processing algorithms. The terminal provides these feature vectors to an emotion analysis module or a remote emotion analysis service. The module performs classification using an emotion recognition model and outputs emotion information, for example an emotion label such as “joy” with a confidence score. The output is an emotion information object that is associated with the request information.
Step 3:

Terminal sends request information and emotion information to the server.

Terminal constructs a message including the structured request object and the emotion information object. The input is the internal data structures created in Step 1 and Step 2. The terminal serializes these data structures into a network message, for example a JSON document, and sends the message via a secure protocol to the server. The output is the transmitted message, which is received and parsed by the server.
Step 4:

Server receives and stores request information and emotion information.

Server accepts the incoming network message and verifies integrity and authentication. The input is the serialized message containing request and emotion information. The server deserializes the message into internal data structures and validates field values. The server stores the request information and the associated emotion information in temporary memory and may log them in persistent storage together with a timestamp and user identifier. The output is an in-memory session context object that will be used in subsequent processing.
Step 5:

Server retrieves past use history information and generates interest information.

Server uses the user identifier from the session context as input and queries a database for stored past use history information, such as previously consumed topics, listening durations, skip events, and historical emotion records. The input is the user identifier and database contents. The server performs data aggregation, for example summing listening durations per topic and counting positive or negative reactions. The server computes topic preference scores and normalizes them to obtain a probability distribution over topics. The output is interest information represented as a vector or list of topics with associated weights.
Step 6:

Server generates search information based on request information and interest information.

Server takes as input the request information (for example, query text and selected categories) and the interest information vector. The server applies a mapping algorithm that combines explicit query terms with top-weighted topics from the interest vector. The server constructs search queries and associated parameters, such as time range and sentiment filters. For example, if the request includes “positive news” and the interest information emphasizes “environment,” the server sets a polarity parameter to filter for positive content related to environment. The output is search information including one or more query strings and parameter sets.

### Step 7:

Server acquires related information from external information sources.

Server sends the generated search information to external information sources through the communication interface. The input is the search queries and parameters. The server forms HTTP requests and transmits them to remote content providers. The external sources respond with structured documents containing titles, body text, dates, and other metadata. The server collects these responses and parses them into internal document objects. The output is a collection of related information, each element containing at least text content and metadata.
Step 8:

Server generates analysis information by natural language processing and summarization.

Server uses the related information collection as input to the natural language processing module. The server cleans the text by removing markup, tokenizes the text, segments it into sentences, and assigns part-of-speech tags. The server calculates importance scores for sentences based on term frequency and positional features, and then selects high-scoring sentences as summaries. The server may group sentences by similarity to identify subtopics. The output is analysis information, including a set of key sentences, key phrases, and a structured summary of the related information.
Step 9:

Server combines analysis information, interest information, and emotion information to form a content plan.

Server takes as input the analysis information, the interest information, and the emotion information from the session context. The server applies rules or learned weights to choose which topics to emphasize and how long each section should be. For example, if the user is in a joyful emotion state and prefers environment and technology, the server selects environment and technology summaries and assigns more time to these sections. The server also determines a desired tone, such as “hopeful and friendly” or “calm and reassuring,” based on the emotion information. The output is a content plan specifying sections, topics, relative lengths, and tone attributes.
Step 10:

Server generates a prompt sentence for the generative AI model.

Server uses the content plan and the analysis information as input to the prompt sentence generation module. The server fills a text template with parameters including the user's interests, current emotion, desired length, and structural instructions. The server appends article summaries or key sentences to provide context. For example, the server may generate the following prompt sentence:
“You are a podcast script writer. The listener is interested in positive news about environmental technology and is currently in a joyful mood. Using the following article summaries, create a 6-minute podcast script in English with a hopeful and friendly tone, suitable for listening while commuting. Include an introduction, two main segments, and a short closing. Article summaries: [summary text].”

The output is a prompt sentence string that encodes detailed instructions for the generative AI model.
Step 11:

Server sends the prompt sentence to the generative AI model and obtains explanation information for audio.

Server provides the prompt sentence as input to the generative AI interface module. The server transmits the prompt sentence to a generative AI model endpoint and specifies model parameters such as maximum output length and generation temperature. The generative AI model processes the prompt sentence and returns a generated text sequence. The server receives the generated text and interprets it as explanation information for audio, for example, a complete podcast script with introduction, sections, and closing. The output is the explanation information for audio in text form.
Step 12:

Server prepares the explanation information for speech synthesis.

Server takes the explanation information text as input. The server optionally transforms the text into a markup format, such as SSML, by inserting tags that control pauses, emphasis, and speaking rate. The server uses information from the content plan and emotion information to decide where to insert slower or faster speaking segments and where to emphasize certain sentences. The output is a speech synthesis input document ready to be provided to the speech synthesis engine.
Step 13:

Server generates audio data by speech synthesis.

Server sends the prepared speech synthesis input as input to the speech synthesis engine via the speech synthesis interface module. The engine converts the text or markup into audio waveforms by applying trained models that map phonetic or spectrogram representations to digital audio samples. The server receives the audio samples and encapsulates them in an audio file format, such as a compressed audio format. The output is audio data representing a narration of the explanation information.
Step 14:

Server adjusts playback parameters and mixes background sound.

Server uses the audio data and the emotion information as input to the audio adjustment module. The server adjusts the playback speed by time-stretching the audio within allowed limits, for example, slower for relaxation or faster for concentration. The server adjusts the volume by applying gain control and normalization to achieve a target loudness. The server selects a background sound track according to the emotion information, such as calm music for relaxation or energetic music for joy, and mixes the background sound with the narration audio while keeping the narration dominant. The output is adjusted audio data that incorporates suitable speed, volume, and background sound.
Step 15:

Server distributes the adjusted audio data to the terminal.

Server stores the adjusted audio data in a storage system and generates a reference such as a uniform resource identifier. The input is the adjusted audio data from Step 14. The server constructs a response message including the reference and metadata such as title, estimated duration, and topics. The server sends this response to the terminal via the communication interface. The output is the delivered reference and metadata, which the terminal can use to access the audio data.
Step 16:

Terminal retrieves and plays the audio data for the user.

Terminal receives the response message from the server. The input is the reference and metadata of the audio data. The terminal resolves the reference to retrieve the audio data by streaming or downloading it. The terminal initializes a media playback component, configures initial playback speed and volume, and starts playback. The audio output device converts the digital audio data into sound heard by the user. The output is the actual playback of the audio content to the user.
Step 17:

Terminal monitors user reactions and updates emotion information during playback.

Terminal observes user interactions such as pausing, skipping, or replaying segments, and continues to capture state information from the imaging device and acoustic acquisition device. The input is playback control events, image data, and audio data. The terminal converts the observed actions into reaction information and converts the captured state information into feature vectors for emotion analysis. The terminal updates the emotion information during playback by running emotion analysis processing again. The output is updated reaction information and updated emotion information.
Step 18:

Terminal sends reaction information and updated emotion information to the server.

Terminal collects reaction information and updated emotion information for the current session. The input is the internal logs of user actions and the latest emotion labels. The terminal packages these data into a message with timestamps and sends the message to the server via the communication interface. The output is a transmitted log message that can be used by the server for learning.
Step 19:

Server logs reaction information and emotion information for machine learning.

Server receives the log message containing reaction information and updated emotion information. The input is the serialized reaction and emotion data with associated metadata. The server parses the message, validates fields, and stores the data in the database indexed by user identifier and session identifier. The server may also aggregate basic statistics, such as how long the user listened before skipping. The output is updated stored logs that form a training dataset for machine learning.
Step 20:

Server updates models and conditions by machine learning processing.

Server uses the stored logs as input to the machine learning module. The server constructs feature vectors that include topic distributions, prompt parameters, emotion sequences, and reaction measures such as engagement scores. The server trains or updates a predictive model using a machine learning algorithm, such as a neural network or gradient-boosted trees, to minimize an error function representing the difference between predicted and observed engagement. The output is updated model parameters and updated conditions for generating search information, generating prompt sentences, and adjusting audio playback parameters, which will be applied to subsequent sessions to improve personalization and system efficiency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

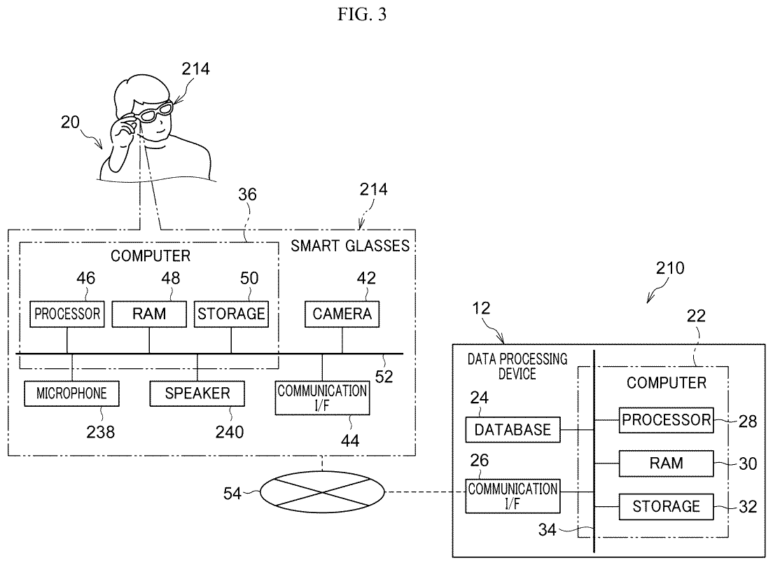

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

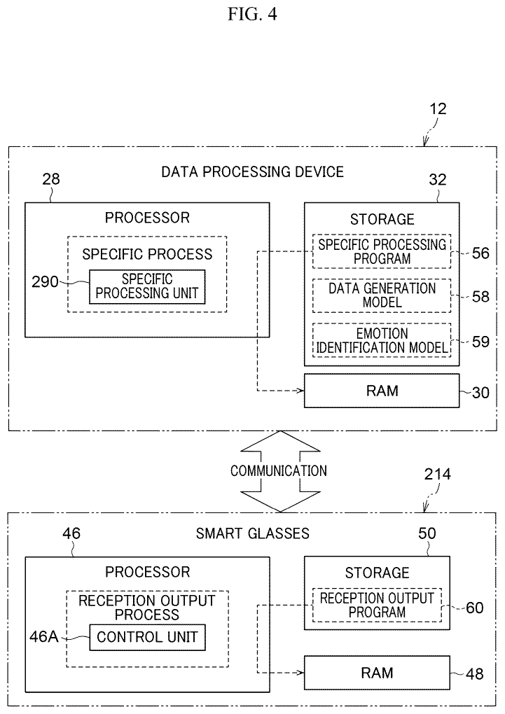

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

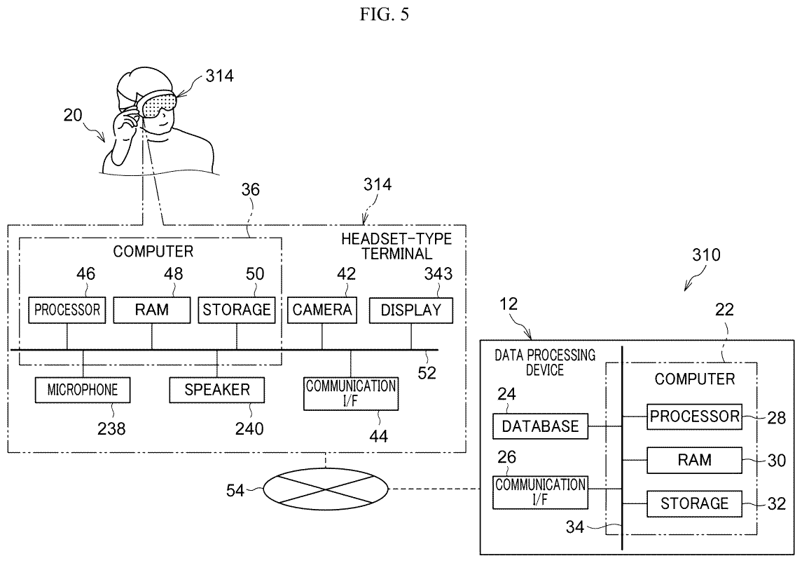

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

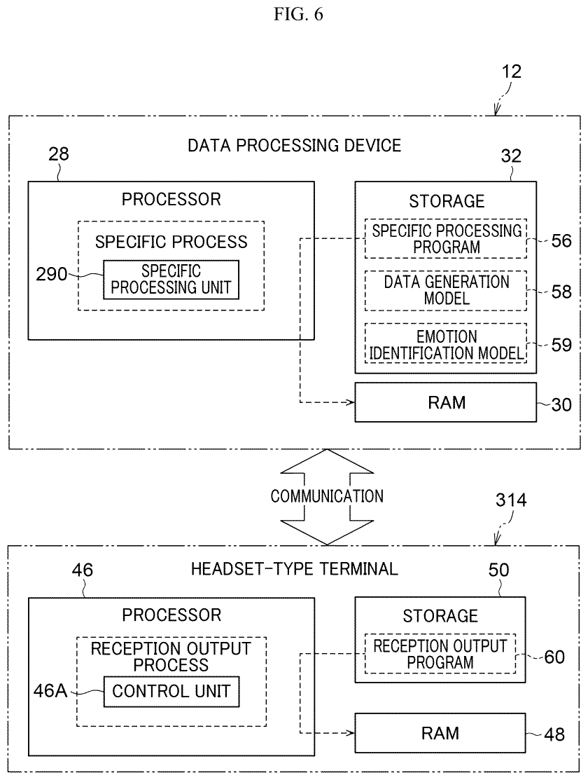

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

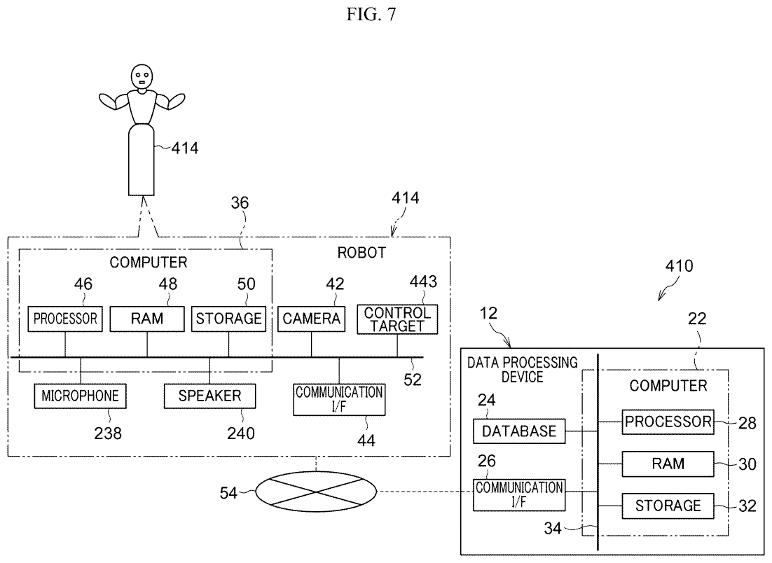

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

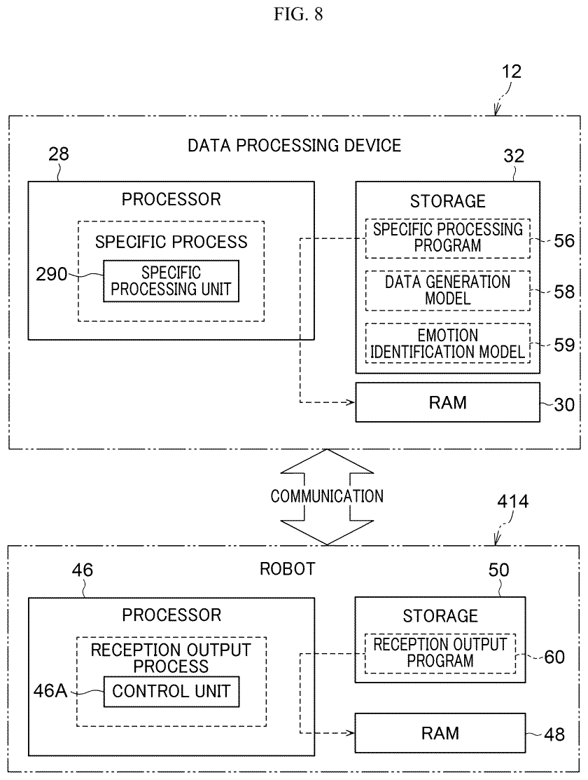

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

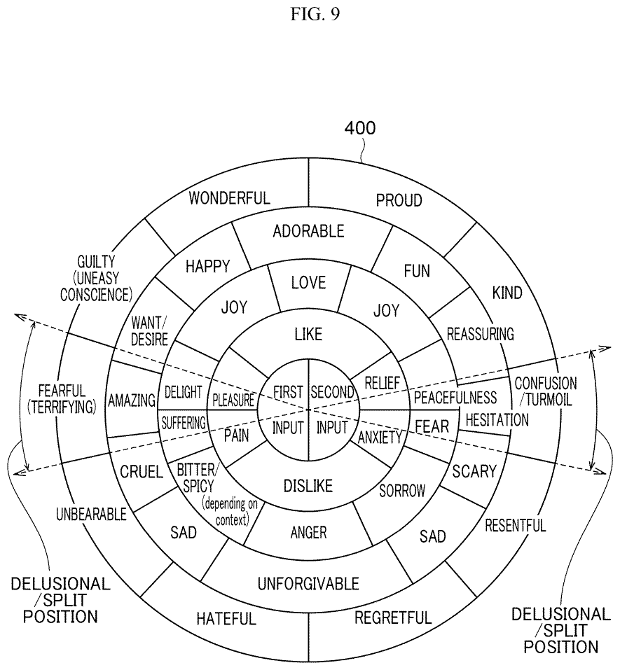

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

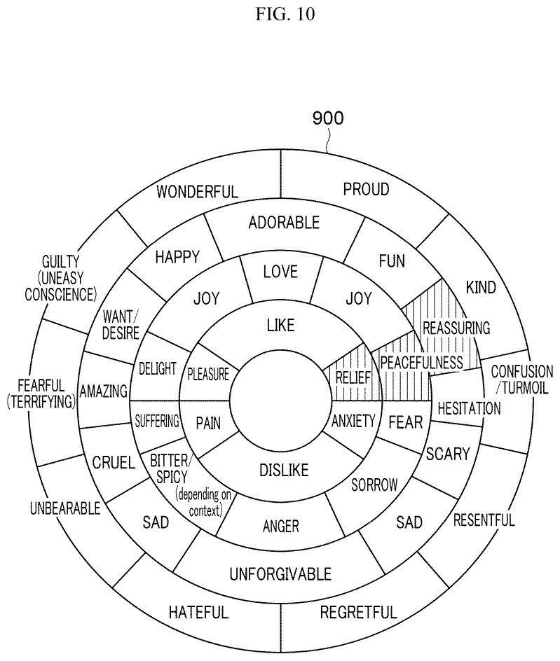

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive a natural language input from a user via a terminal, normalize the natural language input, and generate and transmit a prompt sentence to a generative information processing model so as to convert the natural language input into a search query candidate including search condition information and audio output condition information,
processing model, a plurality of information contents from an information providing apparatus over an information communication network, perform natural language processing on content of the plurality of information contents to execute importance evaluation, duplicate elimination, and summarization processing, and generate a description text for listening,
add, to the description text, speech synthesis instruction information including segmentation information and emphasis information based on a standard description language for speech synthesis, and transmit text data including the speech synthesis instruction information to the terminal, and
cause the terminal to convert the text data and the speech synthesis instruction information into audio data by a speech synthesis technique and to provide the audio data to the user via an output apparatus.

### Supplementary 2

The system according to supplementary 1,
wherein the processor is configured to
calculate, on the basis of keyword information and time range information included in the search query candidate obtained from the generative information processing model, a relevance score for each of the plurality of information contents, rank the plurality of information contents on the basis of the relevance score and publication time information, select a predetermined number of the information contents, and integrally summarize the selected information contents into the description text for listening by using the natural language processing and the generative information processing model.

### Supplementary 3

The system according to supplementary 1,
wherein the processor is configured to
cause the terminal to receive, as additional input from the user, at least one of a playback time condition, an expression difficulty condition, and an interest field condition, update the prompt sentence for the generative information processing model on the basis of the additional input, and regenerate the description text and the speech synthesis instruction information so as to adjust at least one of a length, a speaking rate, and a content detail level of the audio data for a user in a situation where visual acquisition of information is difficult.

### Application Example 1

### Supplementary 1

A system comprising a processor,
wherein the processor is configured to
receive topic information from a user operation terminal and perform a search process to acquire related document information from one or more information providing devices via an information communication network based on the topic information,
analyze the acquired document information by using natural language processing, and generate a prompt sentence, based on the topic information and an analysis result, for instructing a generative AI model in a generative information processing apparatus to generate an explanation text for audio output,
perform an adjustment process for the explanation text acquired from the generative AI model, the adjustment process including at least one of insertion of delimiters, summarization based on importance, and simplification of technical terms in accordance with speaking time, sentence structure, and user attributes, and convert the explanation text into text data for speech synthesis that is inputtable to a speech synthesis processing apparatus,
convert the text data for speech synthesis into audio data by using speech synthesis technology, encode the audio data into a format streamable to the user operation terminal via the information communication network, and transmit the encoded audio data to the user operation terminal, and
update at least one of instruction contents of the prompt sentence and parameters of the adjustment process, based on use history information and evaluation information acquired from the user operation terminal, to optimize generation of the explanation text or the audio data for each user in subsequent processing.

### Supplementary 2

The system according to supplementary 1,
wherein the processor is configured to
transmit search requests to a plurality of types of information providing devices in accordance with the topic information and predetermined acquisition conditions, generate integrated document information from a plurality of pieces of document information acquired from the plurality of types of information providing devices based on at least one of publication time, reliability of an information source, and degree of content duplication, and provide the integrated document information to a process for generating the prompt sentence.

### Supplementary 3

The system according to supplementary 1,
wherein the processor is configured to
adjust at least one of playback speed, volume, delimiter positions, and section structure of the audio data, based on the explanation text acquired from the generative AI model, so that auditory information provision is performed for a user in a situation where visual information acquisition is difficult, and generate audio data adapted to a playback environment of the user operation terminal.

### Example 2

### Supplementary 1

A system comprising a processor,
wherein the processor is configured to
receive a prompt sentence input by a user and extract, from the prompt sentence, information acquisition conditions and audio content specifications,
acquire article information from a plurality of information sources over a communication network based on the information acquisition conditions, normalize the acquired article information, and store the normalized article information as structured data,
perform importance calculation and summarization processing on the structured data using natural language processing technology to generate summary information for each topic, construct a prompt sentence for a generative AI model based on the summary information and the audio content specifications, and instruct the generative AI model to generate a script for audio content,
perform text correction processing and segment division processing on the script output from the generative AI model to generate text data for speech synthesis,
generate audio data from the text data for speech synthesis by using speech synthesis technology and adjust speaker characteristics and playback time of the audio data based on instructions from the generative AI model or based on the prompt sentence,
store the audio data as a file in a media distribution format, generate metadata in the media distribution format, and update distribution information using the metadata, and
make the audio data distributable to a terminal in accordance with the media distribution format.

### Supplementary 2

The system according to supplementary 1,
wherein the processor is configured to classify the article information acquired based on the information acquisition conditions extracted from the prompt sentence, group the article information according to similarity, remove redundant information, and generate the summary information after removal of the redundant information.

### Supplementary 3

The system according to supplementary 1,
wherein the processor is configured to, in a case where a usage mode indicating visual acquisition difficulty is specified in the prompt sentence, control playback speed, pause duration, and emphasis sections of the audio data generated by the speech synthesis technology so as to adjust the audio data as audio content suitable for auditory presentation.

### Application Example 2

### Supplementary 1

A system comprising a processor,
wherein the processor is configured to
receive request information from a user and generate search information for acquiring related information from an information network on the basis of the request information,
analyze the related information and past use history information to generate interest information and emotion information of the user and to generate analysis information obtained by summarizing the related information,
generate a prompt sentence for instructing a generative artificial intelligence model to generate explanation information for audio on the basis of the analysis information and the interest information and the emotion information,
transmit the prompt sentence to the generative artificial intelligence model and obtain the explanation information for audio generated by the generative artificial intelligence model, execute speech synthesis processing on the explanation information for audio to generate audio data and adjust a playback speed and a volume and a background sound of the audio data in accordance with the emotion information,
distribute the adjusted audio data to a terminal device via a communication unit, and update, in a learning manner, the interest information and conditions for generating the prompt sentence on the basis of reaction information and emotion information of the user transmitted from the terminal device.

### Supplementary 2

The system according to supplementary 1,
wherein the processor is configured to
cause the terminal device to generate the emotion information by performing emotion analysis processing on state information of the user acquired from an imaging device and an acoustic acquisition device of the terminal device, to receive the emotion information from the terminal device, and to change style information and content structure information of the prompt sentence for instructing the generative artificial intelligence model in accordance with the emotion information.

### Supplementary 3

The system according to supplementary 1,
wherein the processor is configured to
store the reaction information and the emotion information of the user in association with a history of summarizing processing of the related information, generating processing of the explanation information for audio, and adjustment processing of the audio data, and to optimize, by machine learning processing, conditions for generating the search information and conditions for generating the prompt sentence and conditions for adjusting the playback speed and the volume of the audio data for a subsequent processing.

What is claimed is:

1. A system comprising:
circuitry configured to:
receive, via a communication interface coupled to a packet-switched network, input data from a terminal device;
generate, based on the input data, query data and transmit the query data to one or more information providing apparatus via the packet-switched network to acquire a plurality of document data items;
perform natural language processing on the plurality of document data items to generate structured summary data comprising importance scores and deduplicated content segments;
construct, based on the structured summary data and the input data, an instruction sequence for a generative neural network model, and transmit the instruction sequence to the generative neural network model to acquire generated text data;
convert the generated text data into output signal data by applying synthesis processing parameters derived from the instruction sequence or from the generated text data; and
transmit the output signal data to the terminal device via the communication interface.

2. The system according to claim 1, wherein the input data comprises audio signal data acquired by an acoustic acquisition device of the terminal device, and the circuitry is further configured to perform speech recognition processing on the audio signal data to extract text data prior to generating the query data.

3. The system according to claim 2, wherein the circuitry is further configured to normalize the text data by applying character encoding normalization, case folding, and removal of control characters, and tokenize the normalized text data into tokens using a tokenizer consistent with a vocabulary of the generative neural network model.

4. The system according to claim 1, wherein the circuitry is further configured to transmit query data to a plurality of types of information providing apparatus, calculate a relevance score for each of the plurality of document data items based on keyword information and time range information derived from the input data, and rank the plurality of document data items based on the relevance score and publication time information associated with each document data item.

5. The system according to claim 4, wherein the circuitry is further configured to compare content of the ranked document data items to detect content duplication, remove redundant document data items based on a degree of content duplication exceeding a threshold, and generate integrated document data from remaining document data items based on at least one of publication time, reliability of an information source, and the degree of content duplication.

6. The system according to claim 5, wherein the circuitry is further configured to perform importance calculation on the integrated document data by applying the natural language processing to assign an importance score to each content segment, select a predetermined number of content segments based on the importance scores, and summarize the selected content segments into the structured summary data.

7. The system according to claim 6, wherein the structured summary data comprises, for each deduplicated content segment, a topic label, a relevance score, a source identifier, and a condensed text representation generated by the natural language processing.

8. The system according to claim 1, wherein the circuitry is further configured to construct the instruction sequence by selecting a template from a plurality of stored instruction templates based on the input data, replacing variable portions in the selected template with elements derived from the structured summary data, and outputting the instruction sequence as a completed natural-language string.

9. The system according to claim 8, wherein the generative neural network model comprises a transformer-based architecture including a plurality of self-attention layers, feed-forward sublayers, and layer normalization units, and the circuitry is further configured to transmit the instruction sequence to the transformer-based architecture and receive the generated text data as a sequence of decoded tokens.

10. The system according to claim 9, wherein the circuitry is further configured to parse the generated text data by detecting section delimiters within the generated text data, segmenting the generated text data into a plurality of content sections, and inserting synthesis control markers including at least one of pause duration indicators, emphasis indicators, and speaking rate indicators into each content section to generate annotated text data.

11. The system according to claim 10, wherein the circuitry is further configured to perform text correction processing on the annotated text data including simplification of technical terms, adjustment of sentence length to conform to a token limit, and insertion of transitional phrases between content sections.

12. The system according to claim 11, wherein the circuitry is further configured to convert the annotated text data into the output signal data by invoking a speech synthesis engine that processes the synthesis control markers to adjust at least one of speaking rate, volume, intonation, and pause duration of the output signal data, and encode the output signal data into a streaming format for transmission to the terminal device.

13. The system according to claim 1, wherein the circuitry is further configured to receive, from the terminal device via the communication interface, evaluation information indicating a user assessment of the output signal data, and store the evaluation information in association with the instruction sequence and the synthesis processing parameters used to generate the output signal data.

14. The system according to claim 13, wherein the circuitry is further configured to update at least one of instruction contents of the instruction sequence and the synthesis processing parameters based on use history information comprising a plurality of stored evaluation information entries, to optimize generation of the generated text data or the output signal data for the terminal device in subsequent processing.

15. The system according to claim 14, wherein the circuitry is further configured to receive, from the terminal device, additional input data comprising at least one of a playback time condition, an expression difficulty condition, and an interest field condition, and regenerate the instruction sequence incorporating the additional input data to adjust at least one of a length, a detail level, and a content scope of the generated text data.

16. The system according to claim 15, wherein the circuitry is further configured to perform emotion analysis processing on state information of the user acquired from an imaging device and the acoustic acquisition device of the terminal device to generate emotion information, and modify style information and content structure information of the instruction sequence in accordance with the emotion information.

17. The system according to claim 1, wherein the input data comprises a topic request for news information, the plurality of document data items comprises news article data acquired from a plurality of news information providing servers, the generated text data comprises an audio news script describing summarized news content, and the output signal data comprises spoken audio data with playback speed and volume adjusted for a user in an eyes-busy or hands-busy situation in which visual acquisition of information is difficult.

18. A system comprising:
circuitry configured to:
receive, via a communication interface coupled to a packet-switched network, input data comprising a natural language request from a terminal device;
normalize the input data by applying character encoding normalization and tokenization, and generate query data by transmitting the normalized input data as an instruction sequence to a generative neural network model comprising a transformer-based architecture to obtain search condition information;
transmit the query data to a plurality of information providing apparatus via the packet-switched network to acquire a plurality of document data items, calculate a relevance score for each document data item based on keyword information and time range information, rank the document data items, and generate integrated document data by removing redundant items based on content duplication;
perform natural language processing on the integrated document data to generate structured summary data, construct an instruction sequence for the generative neural network model based on the structured summary data, and acquire generated text data comprising an explanation text segmented into content sections with synthesis control markers;
convert the generated text data into output signal data by invoking a speech synthesis engine that processes the synthesis control markers to control speaking rate, volume, and pause duration, and encode the output signal data into a streaming format; and
transmit the output signal data to the terminal device via the communication interface.

19. The system according to claim 18, wherein the circuitry is further configured to receive evaluation information from the terminal device, store the evaluation information in association with the instruction sequence, and update at least one of instruction contents and synthesis processing parameters based on use history information to optimize generation of the output signal data for the terminal device in subsequent processing.

20. A method performed by circuitry of a system, the method comprising:
receiving, via a communication interface coupled to a packet-switched network, input data from a terminal device;
generating, based on the input data, query data and transmitting the query data to one or more information providing apparatus via the packet-switched network to acquire a plurality of document data items;
performing natural language processing on the plurality of document data items to generate structured summary data comprising importance scores and deduplicated content segments;
constructing, based on the structured summary data and the input data, an instruction sequence for a generative neural network model, and transmitting the instruction sequence to the generative neural network model to acquire generated text data;
converting the generated text data into output signal data by applying synthesis processing parameters derived from the instruction sequence or from the generated text data; and
transmitting the output signal data to the terminal device via the communication interface.
